(19) United States
(12) Patent Application Publication
(10) Pub. No.: US 2010/0302030 A1
(43) Pub. Date: Dec. 2, 2010

(54) INITIAL POSITION DETERMINING METHOD, POSITIONING CALCULATING METHOD, AND POSITION CALCULATING DEVICE

(75) Inventor: Yuichi Yamada, Oota-ku (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/717,065

(22) Filed: Mar. 3, 2010

(30) Foreign Application Priority Data
Mar. 4, 2009 (JP) 2009-050868

(51) Int. Cl. G08B 1/08

(52) U.S. Cl. 340/539.13

(57) ABSTRACT

An initial position determining method is described for a position calculating operation for satellite signals from a positioning satellite. Signals are received from a positioning satellite. A number of candidate ranges are set. An estimated reception frequency for a received signal is calculated. A range may be selected from the candidate ranges based at least in part on a difference between a measured reception frequency and the estimated reception frequency for each range. A representative position from the selected range may be selected as the initial position to be used for a position calculating operation.

This application claims priority to Japanese Patent Application No. 2009-050868, filed Mar. 4, 2009, the entirety of which is hereby incorporated by reference.

### BACKGROUND

The present invention generally relates to an initial position determining method and use of the method for determining an initial position at the time of carrying out a position calculating operation on the basis of a satellite signal from a positioning satellite.

A position calculating device using GPS (global positioning system) may be integrated into a mobile phone, a car navigation apparatus, or the like. A position calculating device may calculate its own position by performing a predetermined position calculation. This may be accomplished by calculating a three-dimensional coordinate value indicating its position and a clock error on the basis of positions of GPS satellites or pseudo distances between the GPS satellites and the system.

In the position calculating operation, a position may be calculated by performing a convergence operation using the Newton method. Since an initial position is used for calculating a position by carrying out the typical convergence operation, various techniques for determining the initial position have been studied. For example, Japanese Patent Application No. 2006-71460 discloses a technique of determining an initial position to be used in the current position calculating operation by the use of a position error included in the position calculated by the previous position calculating operation.

Known position calculating devices often determine an initial position using a fractional part (code phase) of a pseudo random noise (PRN) code, which is a type of a spread code included in a satellite signal from a GPS satellite. The PRN code is a signal with a bit rate of 1.023 Mbps and a bit length of 1,023 bit (=1 msec=300 km). Accordingly, when the initial position is in an error range of 150 km from a true position, it may be possible to carry out a position convergence operation using the fractional part (code phase) of the PRN code. As a result, in some instances it may be necessary to set the error of the initial position to the range of 150 km or less in the known position calculating operation.

However, it may be difficult to acquire the initial position close to the true position of the position calculating device. For example, the position calculating device may be turned on and the position calculating operation carried out for the first time after traveling by air plane. In some cases, therefore, the initial position may be more than 1000 km from the true position of the position calculating device. Even in these cases, it may be preferable to determine an initial position close to the true position of the position calculating device.

### SUMMARY

Novel techniques are described for determining an initial position at the time of carrying out a position calculating operation. Signals are received from one or more positioning satellites. A number of candidate ranges are set. An estimated reception frequency for a received signal is calculated. A range may be selected from the candidate ranges based on the differences between a measured reception frequency and the estimated reception frequency for each range. A representative position from the selected range may be selected as the initial position to be used for a position calculating operation.

In one embodiment, an initial position determining method includes: setting a plurality of candidate ranges; receiving a satellite signal from a positioning satellite; calculating an estimated reception frequency of the satellite signal at a representative position of each of at least a subset of the plurality of candidate ranges; selecting a range from the plurality of candidate ranges based at least in part on a difference between a reception frequency measured substantially at the time of receiving the satellite signal and the estimated reception frequency; and identifying the representative position from the selected range as the initial position to be used for a position calculating operation performed using one or more signals from the positioning satellite.

As another embodiment of the invention, a position calculating device includes a receiver module and a processor module. The receiver module may be configured to receive a satellite signal from a positioning satellite. The processor module may be configured to: set a plurality of candidate ranges; calculate an estimated reception frequency of the satellite signal at a representative position of each of at least a subset of the plurality of candidate ranges; select a range from the plurality of candidate ranges based at least in part on a difference between a reception frequency measured substantially at the time of receiving the satellite signal and the estimated reception frequency; and, identify the representative position from the selected range as the initial position to be used for a position calculating operation performed using one or more signals from the positioning satellite.

The method or device described above may further include one or more of the following features. In some embodiments, a traveling speed and/or a traveling direction may be detected, wherein the estimated reception frequency is calculated using the traveling speed and the traveling direction. In some embodiments, a rough position and a reliability indication for the rough position are received, and the number of candidate ranges and/or the location of the candidate ranges to be set is based on the rough position and the reliability indication.

In some embodiments, for each of the plurality of candidate ranges, an estimated reception frequency is calculated for each of a plurality of additional positioning satellites. For each of the candidate ranges, differences between the estimated reception frequencies of the additional positioning satellites and the measured reception frequency are calculated. The calculated differences for each of the plurality of candidate ranges are summed, and the range is selected based at least in part on the summed differences. In one embodiment, a signal strength for signals from each of the additional positioning satellites is measured, and the calculated differences are weighted in response to the measured signal strength.

In some embodiments, a grid pattern is established corresponding to an area of the earth, wherein each of the plurality of candidate ranges corresponds to a grid of the grid pattern. In some embodiments, a subset of the plurality of candidate positions is selected based at least in part on a difference between a geometrical distance between the plurality of candidate positions and the positioning satellites and a pseudo distance calculated using the satellite signals from the positioning satellites. The plurality of candidate positions may be reduced to the selected subset, and the difference between the measured reception frequency and the estimated reception frequency may be calculated for the selected reduced plurality of candidate positions. In one embodiment, a position at which the position calculating operation is carried out is then calculated using the initial position. The methods described herein may be performed by a mobile phone, and the positional satellite may be a global positioning system satellite.

### BRIEF DESCRIPTION OF THE DRAWINGS

The invention will be described with reference to the accompanying drawings, wherein like numbers reference like elements.

FIG. 1 is a diagram schematically illustrating a configuration of a position calculating system according to various embodiments of the invention.

FIG. 2 is a diagram illustrating a principle of determining an initial position according to various embodiments of the invention.

FIG. 3 is a diagram illustrating a principle of determining an initial position according to various embodiments of the invention.

FIG. 4 is a diagram illustrating a principle of determining an initial position according to various embodiments of the invention.

FIG. 5 is a diagram illustrating a method of extracting a processing frame according to various embodiments of the invention.

FIG. 6 is a diagram illustrating a method of extracting a processing frame according to various embodiments of the invention.

FIG. 7 is a block diagram illustrating a functional configuration of a mobile phone according to various embodiments of the invention.

FIG. 8 is a diagram illustrating an example of data stored in a ROM of the mobile phone according to various embodiments of the invention.

FIG. 9 is a diagram illustrating an example of data stored in a flash ROM of the mobile phone according to various embodiments of the invention.

FIG. 10 is a diagram illustrating an example of data stored in a RAM of the mobile phone according to various embodiments of the invention.

FIG. 11 is a diagram illustrating a data structure of initial position reliability setting data according to various embodiments of the invention.

FIG. 12 is a diagram illustrating a data structure of measurement data according to various embodiments of the invention.

FIG. 13 is a diagram illustrating a data structure of grid data according to various embodiments of the invention.

FIG. 14 is a diagram illustrating a data structure of candidate initial position data according to various embodiments of the invention.

FIG. 15 is a diagram illustrating a data structure of sensor data according to various embodiments of the invention.

FIG. 16 is a diagram illustrating a data structure of priority data according to various embodiments of the invention.

FIG. 17 is a flowchart illustrating a flow of a main process according to various embodiments of the invention.

FIG. 18 is a flowchart illustrating a flow of a position calculating process according to various embodiments of the invention.

FIG. 19 is a flowchart illustrating a flow of the position calculating process according to various embodiments of the invention.

FIG. 20 is a flowchart illustrating a flow of an extended grid search process according to various embodiments of the invention.

FIG. 21 is a flowchart illustrating a flow of an initial position estimating and reducing process according to various embodiments of the invention.

FIG. 22 is a flowchart illustrating a flow of a first APR value calculating process according to various embodiments of the invention.

FIG. 23 is a flowchart illustrating a flow of a second APR value calculating process according to various embodiments of the invention.

FIG. 24 is a flowchart illustrating a flow of a Doppler check process according to various embodiments of the invention.

FIG. 25 is a flowchart illustrating a flow of a second position calculating process according to various embodiments of the invention.

FIG. 26 is a flowchart illustrating a flow of a second initial position estimating and reducing process according to various embodiments of the invention.

### DESCRIPTION OF EXEMPLARY EMBODIMENTS

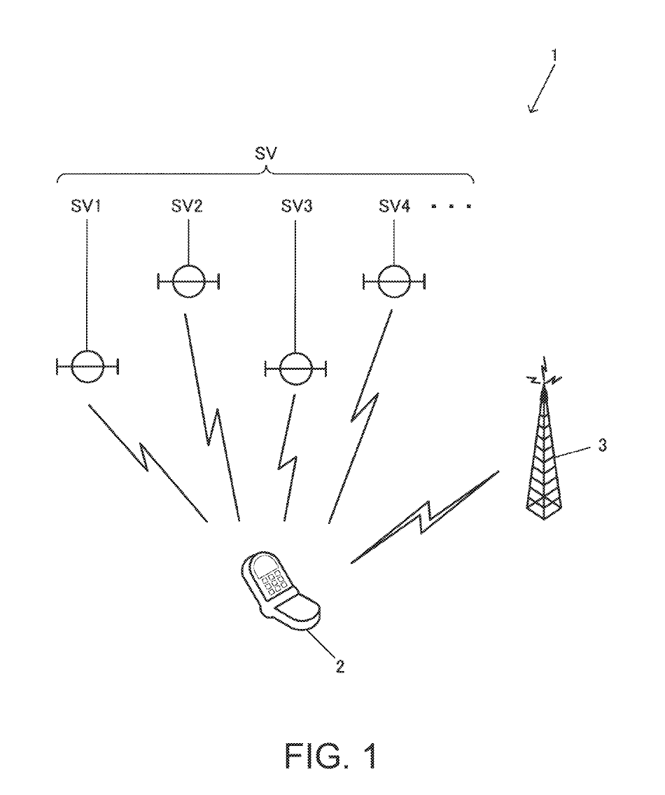

Hereinafter, various embodiments of the invention will be described with reference to the accompanying drawings. Embodiments may be described with reference to a mobile phone (e.g., mobile phone 2 of FIG. 1). The mobile phone 2 may move by being carried by the user. For this reason the drawings may be described referring to a mobile phone or a user. However, the invention is not limited to such examples, as aspects of the invention may be used with a range of other devices and techniques.

### 1. System Configuration

FIG. 1 is a diagram schematically illustrating the configuration of a position calculating system 1 according to an embodiment of the invention. The position calculating system 1 includes a mobile phone 2 which is a type of electronic apparatus having a position calculating device, a base station 3 of the mobile phone, and GPS satellites SV (SV1, SV2, SV3, SV4, . . . ).

The mobile phone 2 may be any electronic apparatus allowing a user to make a telephone call or to transmit and receive e-mails, and may perform the original function as a mobile phone, such as a telephone call or transmission and reception of e-mails, by communicating with the base station 3. The mobile phone 2 includes a position calculating device performing a position calculating function and serves to calculate a position on the basis of GPS satellite signals received from the GPS satellites SV. The mobile phone 2 may display a picture obtained by plotting the calculated position on a display unit.

In some embodiments, the mobile phone 2 requests a rough position from the base station 3 when a position calculating process is first performed after it is turned on or when a long time passes after the performance of the previous position calculating process. The mobile phone acquires the rough position and the reliability of the rough position (for example, receiving an indication of a maximum distance the rough position is apart from the true position of the mobile phone 2) from the base station 3. The mobile phone 2 determines an initial position at the time of performing the position calculating operation in accordance with the novel principles described below. The mobile phone 2 measures its position by performing a position calculating operation using the determined initial position.

The base station 3 is a wireless base station provided by a service provider of the mobile phone and allows the mobile phone 2 to make a telephone call or to transmit and receive e-mails, by transmitting a base station signal to the mobile phone 2 and by making a base station communication with the mobile phone 2. The base station 3 serves as an external system providing a rough position, and the reliability of the rough position to the mobile phone 2 as a request source in response to a request from the mobile phone 2.

The rough position can be set to, for example, a predetermined position of each country or each region. For example, the position information of Tokyo may be given as the rough position in Japan and the position information of Beijing may be given as the rough position of China. Since known methods may be used as the method of calculating the reliability of the rough position, description thereof is not given in this embodiment.

### 2. Principles

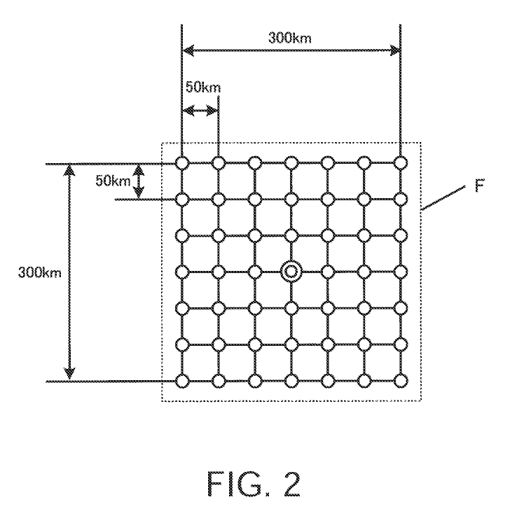

FIGS. 2 to 6 are diagrams illustrating examples of a novel principle used to determine an initial position.

The initial position is used for the mobile phone 2 to perform the position calculating operation (more specifically, position convergence operation), to determine a satellite to be captured (hereinafter, referred to as “satellite for capture”), or to calculate a geometrical distance between the mobile phone 2 and the satellite for capture. Accordingly, it may be desirable to set the initial position closer to the true position of the mobile phone 2.

Consider an example when the rough position acquired from the base station 3 has an error of ±150 km or less from the true position of the mobile phone 2; it is presumed that the location of the mobile phone 2 is included in a range of 300 square km centered on the acquired rough position. Accordingly, it is possible to determine the initial position close to the true position of the mobile phone 2 in an error range of at least 300 km or less.

Specifically, for example, as shown in FIG. 2, a two-dimensional area (hereinafter, referred to as “frame F”), which is centered on the rough position (indicated by a double circle in the drawing) and which has the same altitude as the rough position, is virtually arranged on the earth. Candidate positions referred to as grids with a pitch of 50 km are arranged in a grid pattern in the frame. It will be described that the two-dimensional frame is arranged so that all the altitudes of the grids are the same, but a three-dimensional frame may be arranged so that the altitudes of the grids are the altitudes of the earth's surface in the grids.

The distance between each grid and the satellite for capture may be calculated from the positional coordinates by the use of Expression 1. In this embodiment, the distance between the grid and the satellite for capture calculated from the positional coordinates is referred to as “geometrical distance”.

GRᵢ=\sqrt{(Xᵢ−x)²+(Yⁱ−y)²+(Zᵢ−z)²} (1)

Here, “GR” represents the geometrical distance and the subscript “i” represents the number of the satellite for capture. (Xᵢ, Yᵢ, Zᵢ) represents the positional coordinates of the satellite for capture and (x, y, z) represents the positional coordinate of the grid.

The GPS satellite signals transmitted from the GPS satellites SV are modulated by a direct spectrum spread method using PRN codes, which are a kind of spread code, different for each satellite. In this case, by performing a correlation process on a replica code generated in the device and the PRN codes, it is possible to detect the phases of the PRN codes (hereinafter, referred to as “code phase”). It is possible to calculate the pseudo distance “PR” between the mobile phone 2 and the satellite for capture from the code phases.

The position convergence operation is carried out on each grid using the difference “δR=PR−GR” between the pseudo distance “PR” and the geometrical distance “GR” and using the corresponding grid as the interim initial position. For example, a successive approximation method (Newton-Raphson method) can be used for the convergence operation and the grid on which the solution is convergent is determined as the initial position in the position calculating operation.

When the error included in the rough position given from the base station 3 is 150 km or less, it is possible to determine the initial position, as described above, by assuming one frame made up of a square with sides 300 km and carrying out the position convergence operation on the grids in the frame. However, when the rough position probably has an error greater than 150 km, the location of the mobile phone 2 is not necessarily included in the frame made up of a square with sides 300 km centered on the given rough position. Accordingly, it may be necessary to extend the search range for the initial position.

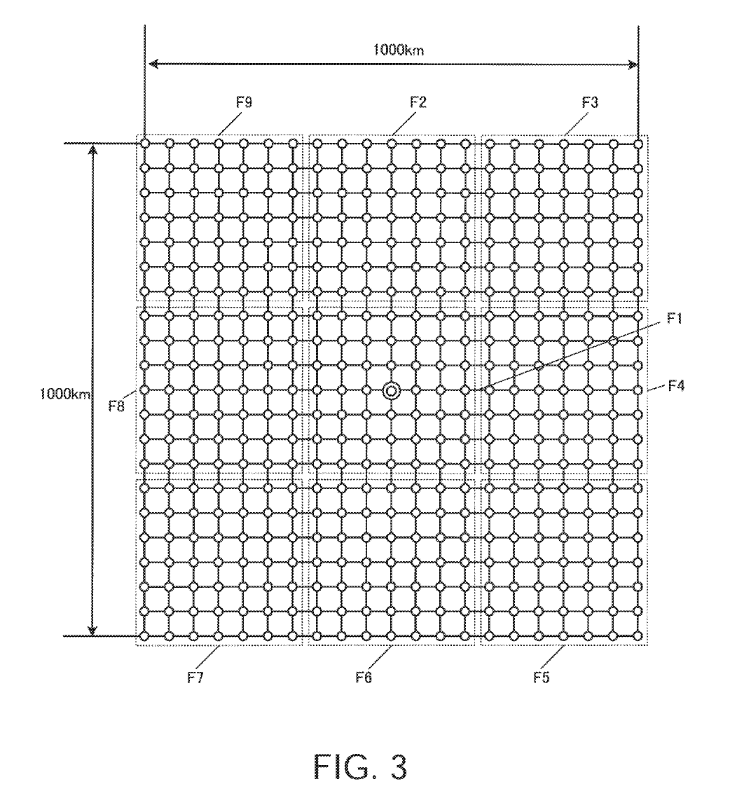

Specifically, the position of the frame to be set is determined on the basis of the given rough position and the number of frames to be set is determined on the basis of the reliability of the given rough position. For example, when a rough position with a reliability of 500 km is given from the base station 3, an area made up of a square with sides of 1000 km may be formed, as shown in FIG. 3, by setting a frame F1 centered on the given rough position (indicated by a double circle in the drawing) and setting eight frames F2 to F9 around the center frame. Then, the initial position is determined by carrying out the position convergence operation on all the grids included in frames F1 to F9.

However, in the example shown in FIG. 3, since 7×7=49 grids are included in one frame, 49×9=441 grids exist in the nine frames. Accordingly, when the position convergence operation is carried out on all the grids, the amount of calculation greatly increases. When the search range for the initial position is extended, plural convergent points may be measured by the position convergence operation and it may be difficult to select the grid to be set as the initial position in some cases.

In this embodiment, to solve the above-mentioned problems, a frame is selected and extracted on the basis of the difference between a theoretical reception frequency when it is assumed that the GPS satellite signal is received at a representative grid (representative position) in each frame and the reception frequency of the GPS satellite signal actually measured by the mobile phone 2 for each frame. At this time, the theoretical reception frequency may be calculated considering the traveling speed and the traveling direction of the mobile phone 2.

Then, the grids included in the selected frame are reduced using an inductive residual APR (hereinafter referred to as “APR value”). By carrying out the position convergence operation on the reduced grids, it is possible to reduce the amount of calculation and to prevent plural convergent points from being measured in the position convergence operation.

Here, the APR value is calculated by the use of Expression 2.

$$APR = {\sum }_{i}^{N} {( δ {R}_{i} )}^{2} = {\sum }_{i}^{N} {( {PR}_{i} - {GR}_{i} )}^{2} \qquad ( 2 )$$

Here, “N” represents the number of satellites for capture. The APR value is given as the sum of squares of the difference “δR” between the pseudo distance “PR” and the geometrical distance “GR” of each satellite for capture.

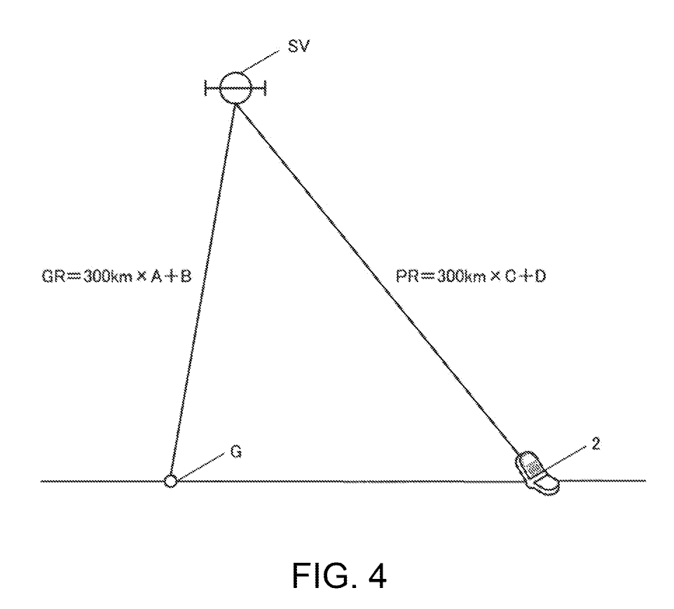

FIG. 4 is a diagram illustrating an example of the process for determining an initial position and calculating a position in this embodiment. The PRN code is a signal having a bit rate of 1.023 Mbps and a bit length of 1,023 bit (=1 msec=300 km). The distance (geometrical distance) between a GPS satellite SV and a grid can be expressed as a distance obtained by adding a fractional part to an integral multiple of 300 km which is a wavelength corresponding to 1 ms as a repetition cycle of the PRN code. For example, in FIG. 4, the geometrical distance between a grid G and a satellite SV can be expressed by “GR=300 km×A+B”. Similarly, the pseudo distance between the mobile phone 2 and the satellite SV can be expressed by “PR=300 km×C+D”.

First, the reception frequency (hereinafter referred to as “estimated reception frequency”) is calculated assuming that the mobile phone 2 travels at the current traveling speed in the traveling direction at the representative grid (representative position) selected from the grids included in each of the frames ((1) in FIG. 4).

The traveling speed and the traveling direction of the mobile phone 2 may be acquired, for example, on the basis of the detection result of a sensor unit with a speed sensor and a direction sensor disposed in the mobile phone 2. The representative grid can be set to, for example, the center grid of each frame.

More specifically, a satellite position, a satellite traveling speed, and a satellite traveling direction of the GPS satellite at present are calculated as satellite information on the basis of satellite orbit information (for example, ephemeris data) acquired and stored in advance. The estimated reception frequency may be calculated by a known method using the calculated satellite information, the position of the representative grid, and the traveling speed and the traveling direction of the mobile phone 2 detected by the sensor unit.

The difference between the estimated reception frequency at each representative grid and the reception frequency (hereinafter referred to as “measured reception frequency”) actually measured by the mobile phone 2 is calculated and a frame to be processed (hereinafter referred to as “processing frame”) is extracted on the basis of the calculated difference in reception frequency ((2) in FIG. 4).

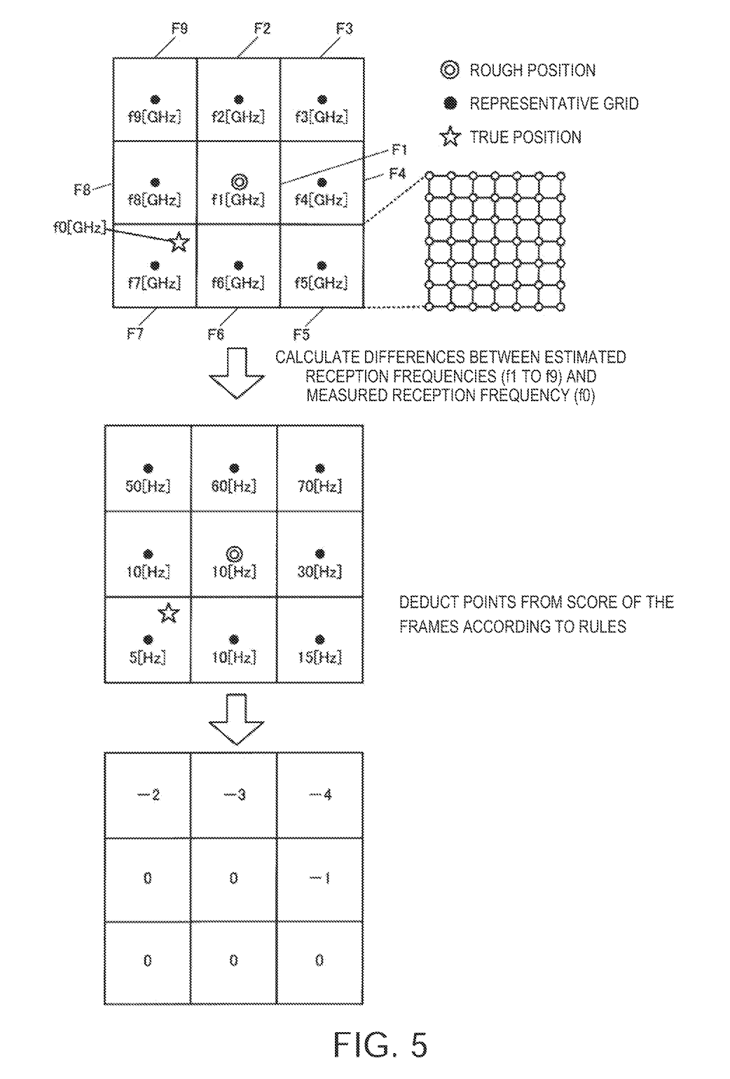

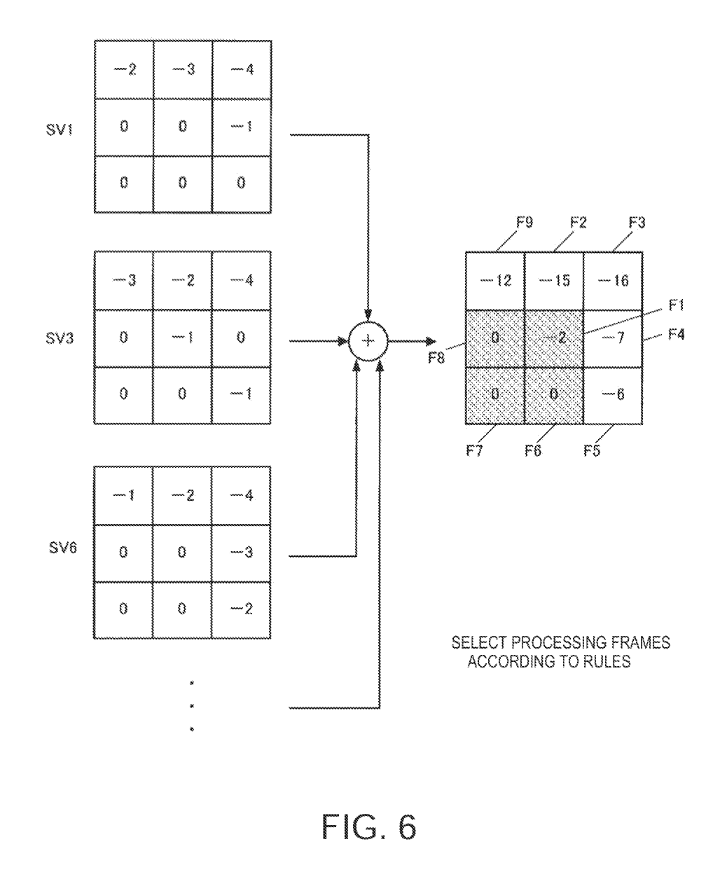

FIGS. 5 and 6 are diagrams illustrating an example of a method of extracting the processing frame. Here, it is assumed that nine frames F1 to F9 are set as shown in FIG. 3. First, a score of each frame is calculated on the basis of the calculated difference in reception frequency. The score is calculated, for example, by deducting the score from “0 point”.

By way of a more specific example, as shown in FIG. 5, assume that the center grids of the frames F1 to F9 are set to the representative grids, respectively, and f1 to f9 [GHz] are acquired as the calculation result of the estimated reception frequency when the GPS satellite signals are received by the representative grids. Also assume that the measured reception frequency is f0 [GHz] when the GPS satellite signal is actually received by the mobile phone 2 at the actual position.

In this case, the difference between the estimated reception frequency and the measured reception frequency is calculated for each frame. As a result, it is assumed that the differences in reception frequency of the frames F1 to F9 are 10[Hz], 60[Hz], 70[Hz], 30[Hz], 15[Hz], 10[Hz], 5[Hz], 10[Hz], and 50[Hz], respectively. Here, the differences in reception frequency are absolute values.

Then, the scores of the frames are calculated on the basis of the calculated differences in reception frequency. Various methods can be used to calculate the scores. For example, a method of calculating an average of the differences in reception frequency and deducting the score of the frame in which the difference in reception frequency is greater than the calculated average value more significantly for the frame having a larger difference can be used. In the example shown in FIG. 5, since the average value of the differences in reception frequency is 29 [Hz], the scores of the frames of which the difference in reception frequency is greater than 29 [Hz] are deducted. As a result, the score of the frame F4 is “−1”, the score of the frame F9 is “−2”, the score of the frame F2 is “−3”, the score of the frame F3 is “−4”, and the scores of the other frames are “0”.

In another method, for example, the score of the frame of which the difference in reception frequency is greater than the minimum value +α may be deducted more significantly for the frame having a larger difference. In the example shown in FIG. 5, the minimum value of the difference in reception frequency is 5[Hz]. In this case, the score of the frame of which the difference in reception frequency is greater than 25 [Hz] is deducted, for example, with α=20 [Hz]. As a result, the scores of four frames F3, F2, F9, and F4 are deducted sequentially from the frame of which the difference in reception frequency is the largest.

A predetermined number of frames may be extracted sequentially from the frame of which the difference in reception frequency is the largest and the scores thereof may be deducted more significantly for the frame having a larger difference. In the example shown in FIG. 5, for example, when four frames are extracted, four frames F3, F2, F9, and F4 are extracted and deducted in score sequentially from the frame having the largest difference in reception frequency.

The scores of the frames are calculated in the above-mentioned order for the respective satellites for capture. Since the reception frequencies of the satellites for capture are different, the scores of the frames are calculated for the respective satellites for capture. The calculated scores are summed up for each frame and the priority of the frame is calculated. The priority is an indicator value used to determine the priority order of selecting the processing frames and is expressed by a value of 0 or less. “0” represents the highest priority and a smaller value represents a lower priority.

Specifically, as shown in FIG. 6, the priority of each frame is calculated by summing up the scores of each frame calculated on the satellites for capture (SV1, SV3, SV6, . . . ) every frame. The processing frames are extracted on the basis of the calculated priorities. For example, the frames of which the priority is greater than a predetermined threshold value may be extracted as the processing frames or a predetermined number of frames may be extracted as the processing frames sequentially from the frame having the highest priority.

For example, it is assumed that the priorities of the frames F1 to F9 are “−2”, “−15”, “−16”, “−7”, “−6”, “0”, “0”, “0”, and “−12”, respectively. In this case, when the threshold value is “−5” and the frames having the priority higher than “−5” are extracted as the processing frames, four frames of F1, F6, F7, and F8 are extracted as the processing frames.

Referring back to the example of FIG. 4, after the processing frames are extracted, the geometrical distances “GR” of the grids included in each processing frame are calculated and the fractional parts thereof are calculated. The fractional parts of the measured pseudo distances “PR” are calculated. Then, by calculating the APR value using the difference between the fractional part “D” of the pseudo distance “PR” and the fractional part “B” of the geometrical distance “GR”, and selecting N grids sequentially from the grid having the smallest APR value, the grids are reduced to N grids ((3) in FIG. 4). In the example, the number of grids “N” to which the grids are reduced is “5 to 20”.

By carrying out the position convergence operation by m repetition times using each of the N reduced grids as candidate initial positions, the grids are additionally reduced to M grids ((4) in FIG. 4). The number of repetition times “m” of the position convergence operation is, in one embodiment “5” or less, and may be “2 to 3”. In some instances, the number of grids of which the solution is convergent by the m position convergence operations out of the N grids is substantially “2 or 3”. Here, the number of reduced grids is M.

Then, the APR value of each of the M reduced grids is calculated using the geometrical distance “GR” and the pseudo distance “PR”. The grid having the minimum APR value is selected and determined as the initial position ((5) in FIG. 4).

When the initial position is determined, the position of the mobile phone 2 is calculated by carrying out the position convergence operation by n repetition times using the initial position ((6) in FIG. 4). In this case, the number of repetition times “n” of the position convergence operation may be between 6 and 10.

One feature of this embodiment is that a processing frame is selected and extracted from a lot of frames and the grids included in the selected frame are reduced. That is, the grids included in the processing frame may be reduced to 5 to 20 using the fractional part of the geometrical distance and the fractional part of the pseudo distance and the grids may be additionally reduced to 2 to 3 by carrying out the position convergence operation by a small number of repetition times (with a small amount of calculation). Accordingly, in one embodiment, it is possible to select the grid to be set as the initial position with a smaller amount of calculation without carrying out the perfect position convergence operation on all of a large number of grids.

### 3. Functional Configuration

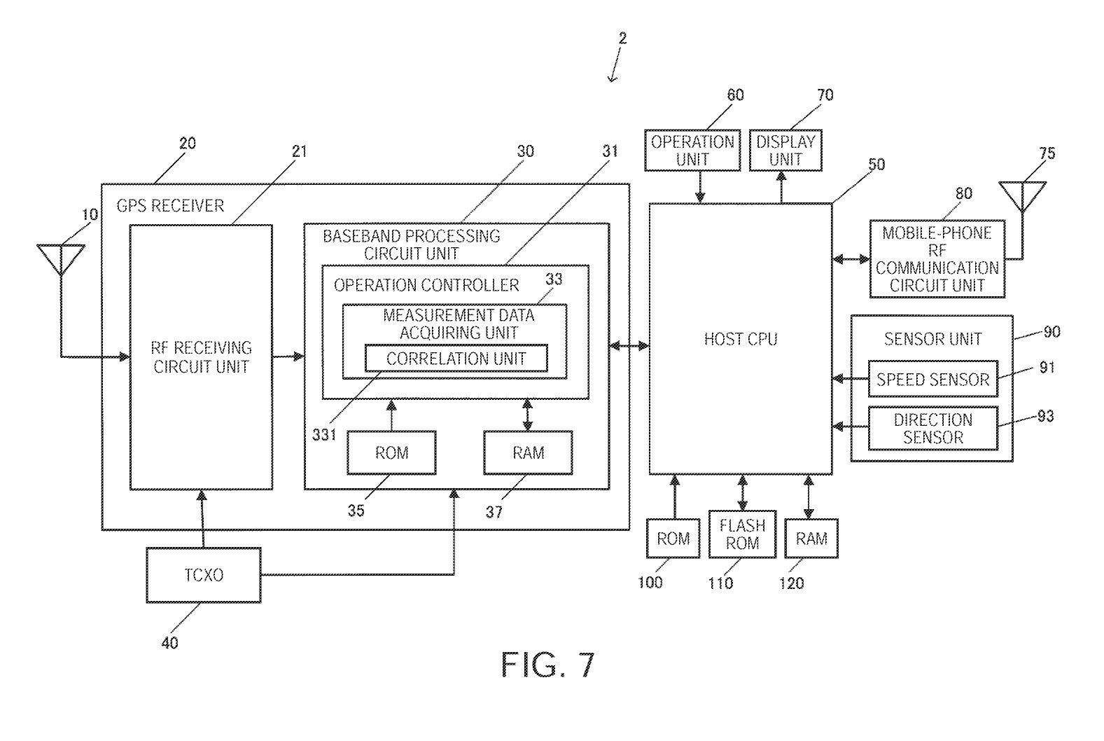

FIG. 7 is a block diagram illustrating an example of the functional configuration of the mobile phone 2 according to this embodiment. The mobile phone 2 includes a GPS antenna 10, a GPS receiver 20, a temperature compensated crystal oscillator (TCXO) 40, a host CPU (Central Processing Unit) 50, an operation unit 60, a display unit 70, a mobile-phone antenna 75, a mobile-phone RF communication circuit unit 80, a sensor unit 90, a ROM (Read Only Memory) 100, a flash ROM 110, and a RAM (Random Access Memory) 120. Some or all of the functions described with reference to FIG. 7 may be performed using other processors and/or device configurations.

The GPS antenna 10 is an antenna for receiving RF (Radio Frequency) signals including the GPS satellite signals transmitted from the GPS satellites and serves to output the received signals to the GPS receiver 20.

The GPS receiver 20 may be a GPS receiver. More specifically, the GPS receiver 20 may be a position calculating circuit calculating the current position of the mobile phone 2 on the basis of the signals output from the GPS antenna 10 and is a functional block corresponding to a so-called GPS receiving device. The GPS receiver 20 may include an RF receiving circuit unit 21 and a baseband processing circuit unit 30. The RF receiving circuit unit 21 and the baseband processing circuit unit 30 may be manufactured as different LSI (Large Scale Integration) chips or may be manufactured as one chip.

In one embodiment, the RF receiving circuit unit 21 is an RF signal processing circuit block and generates an oscillation signal for RF signal multiplication by dividing or multiplying an oscillation signal generated from the TCXO 40. The RF receiving circuit unit 21 downconverts the RF signals into an intermediate frequency signal (hereinafter, referred to as “IF signal”) by multiplying the generated oscillation signal by the RF signals output from the GPS antenna 10. The IF signal may be amplified, and converted into a digital signal by an A/D converter in the RF receiving circuit unit 21. The IF signal may then be output to baseband processing circuit unit 30.

In one embodiment, the baseband processing circuit unit 30 is a circuit unit performing a correlation process on the IF signals output from the RF receiving circuit unit 21 to capture and extract the GPS satellite signal. The baseband processing circuit unit 30 may perform a position calculating process by decoding data and taking out a navigation message or time information. The baseband processing circuit unit 30 may be configured to include an operation controller 31, a ROM 35, and a RAM 37. The operation controller 31 may be configured to include a measurement data acquiring unit 33.

In one embodiment, the measurement data acquiring unit 33 is a circuit unit capturing and tracking the GPS satellite signal from the reception signal (IF signal) output from the RF receiving circuit unit 21, and includes a correlation unit 331. The measurement data acquiring unit 33 may acquire information, such as the Doppler frequency of the captured and tracked GPS satellite signal or the code phase, as measurement values, and output the acquired information to the host CPU 50.

The correlation unit 331 may perform the correlation process of calculating and integrating the correlation between the PRN code included in the received signal and the replica code, for example, using a fast Fourier transform (FFT) process to capture the GPS satellite signal. The replica code is a signal which is pseudo-generated and is obtained by simulating the PRN code included in the GPS satellite signal to be captured.

If a GPS satellite signal to be captured is correct, a PRN code and a replica code included in the GPS satellite signal will match each other (capture success). When the received signal is not the GPS satellite to be captured, the codes are not equal to each other (capture failure). Accordingly, it is possible to determine whether the GPS satellite signal is successfully captured by determining the peak of the calculated correlation value. It is also possible to capture the GPS satellite signal by performing the process of correlating the replica code with the same received signal while sequentially changing the replica code.

The correlation unit 331 may perform the above-mentioned correlation process while changing the frequency of the generated signal of the replica code and the phase of the replica code. When the frequency of the generated signal of the replica code is equal to the frequency of the received signal, and the phase of the replica code is equal to the phase of the PRN code included in the received signal, the correlation value is at a maximum.

More specifically, a predetermined range of frequency and phase may be set as a search range depending on the GPS satellite signal to be captured. In the search range, the correlation process in the phase direction for detecting a start position (code phase) of the PRN code and the correlation process in the frequency direction for detecting the frequency, are carried out. Regarding the frequency, the search range may be determined in a predetermined frequency sweeping range centered on 1.57542 [GHz], which is the carrier frequency of the GPS satellite signal. Regarding the phase, the search range may be determined in a code phase range of 1023 chips, which is the chip length of the PRN code for the phase.

In one embodiment, the TCXO 40 is a temperature compensated crystal oscillator generating an oscillation signal at a predetermined oscillation frequency and outputs the generated oscillation signal to the RF receiving circuit unit 21 and the baseband processing circuit unit 30.

The host CPU 50 is a processor generally controlling the units of the mobile phone 2 in accordance with various programs, such as a system program stored in the ROM 100. The host CPU 50 may display the output position, which is acquired by performing the position calculating process, on the display unit 70.

The operation unit 60 may be an input device including, for example, a touch panel or button switches, and may output signals of the pressed keys or buttons to the host CPU 50. Various instructions, such as a telephone call request and a mail transmitting and receiving request, are input by the operation of the operation unit 60.

The display unit 70 may include a liquid crystal display (LCD) or the like, and produce various displays based on a display signal input from the host CPU 50. A navigation picture or time information may be displayed on the display unit 70.

The mobile-phone antenna 75 is an antenna for transmitting and receiving mobile-phone RF signals to and from the wireless base station provided by a communication service provider of the mobile phone 2.

The mobile-phone RF communication circuit unit 80 is a communication circuit unit of a mobile phone, including an RF conversion circuit and a baseband processing circuit, for a telephone call or the transmission and reception of e-mails, which modulates and demodulates mobile-phone RF signals.

The sensor unit 90 may include various sensors detecting the traveling state of the mobile phone 2 and includes, for example, a speed sensor 91 and a direction sensor 93.

The speed sensor 91 is a sensor detecting the traveling speed of the mobile phone 2 and may employ any sensor that uses the Doppler effect, a spatial filter or the like.

The direction sensor 93 may be a biaxial geomagnetism sensor including an element of which the resistance or impedance increases or decreases depending on the intensity of the magnetic field, and serves to detect the traveling direction of the mobile phone 2.

The ROM 100 is a read-only nonvolatile memory device, and stores the system program causing the host CPU 50 to control the mobile phone 2 or various programs or data for embodying the navigation function.

The flash ROM 110 is a readable and writable nonvolatile memory device, and stores various programs, data, or the like causing the host CPU 50 to control the mobile phone 2, similarly to the ROM 100. The data stored in the flash ROM 110 is not erased even when the mobile phone 2 is turned off.

The RAM 120 is a readable and writable volatile memory device, and forms a work area temporarily storing the system program executed by the host CPU 50, various process programs, processing data of various processes, and process results.

### 4. Data Structure

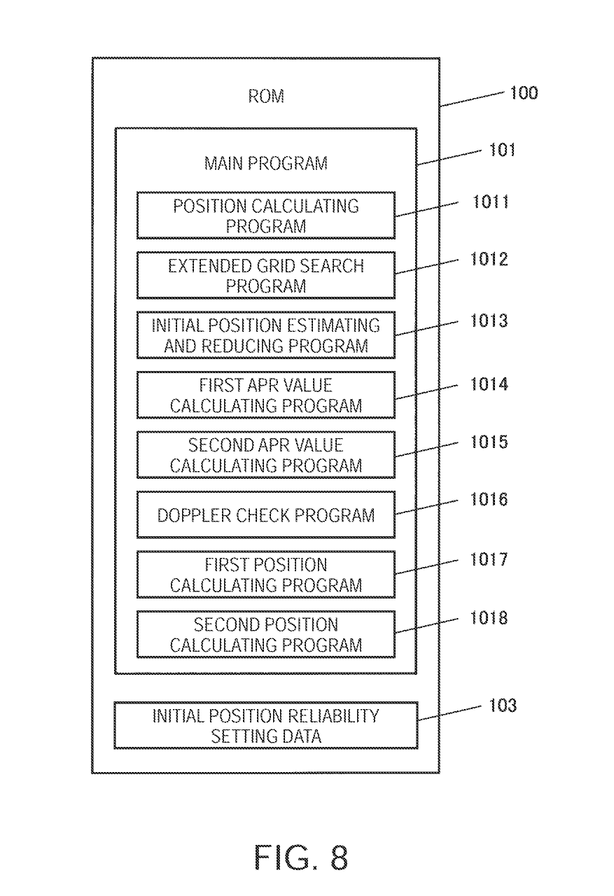

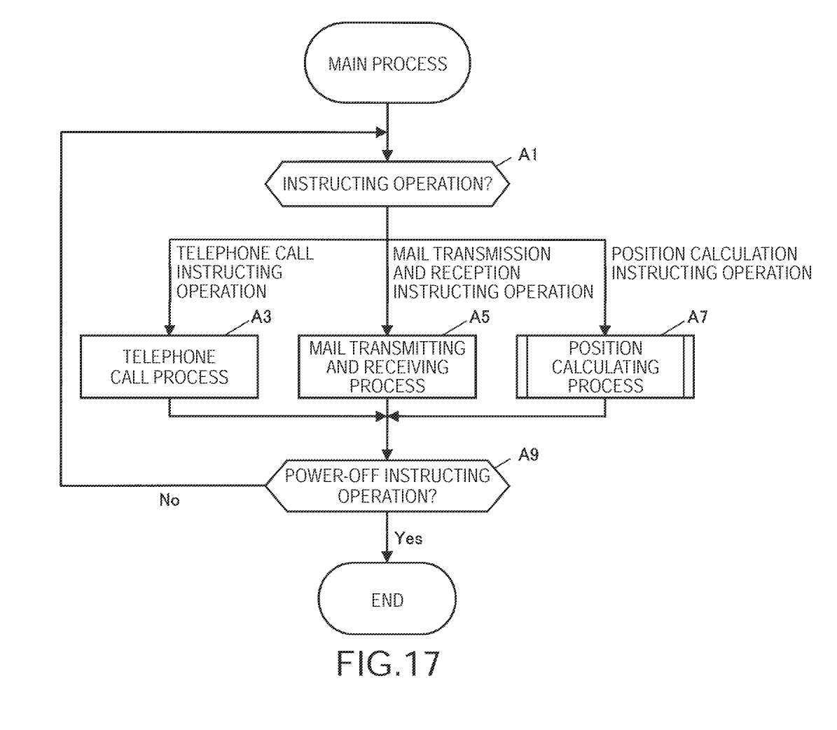

FIG. 8 is a diagram illustrating an example of data stored in the ROM 100. The ROM 100 stores a main program 101, which is read and executed as a main process (see FIG. 17) by the host CPU 50, and initial position reliability setting data 103.

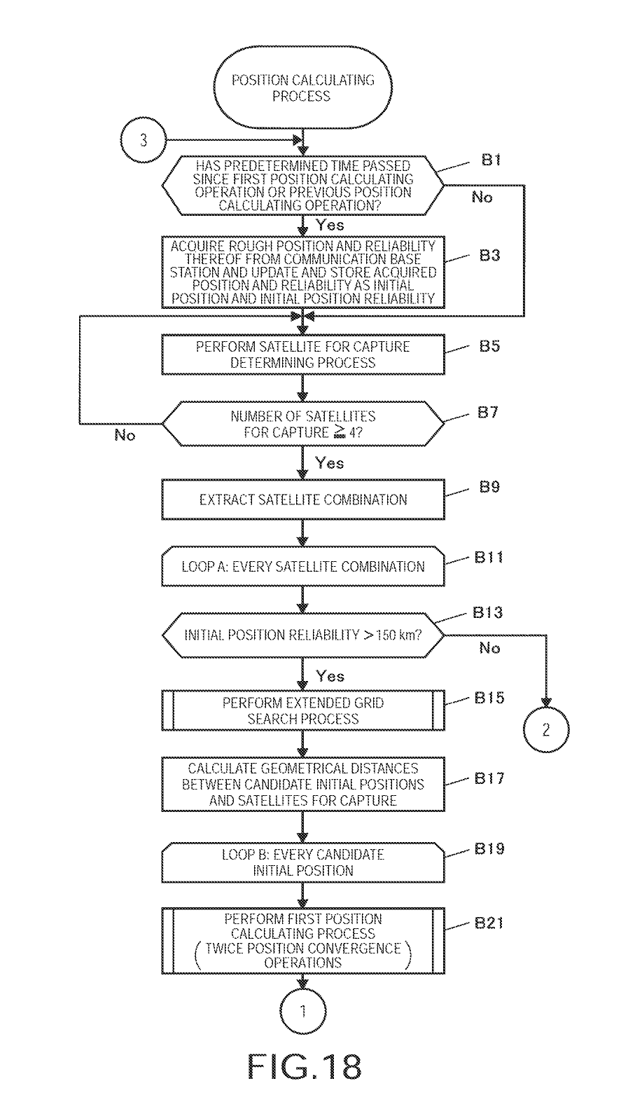

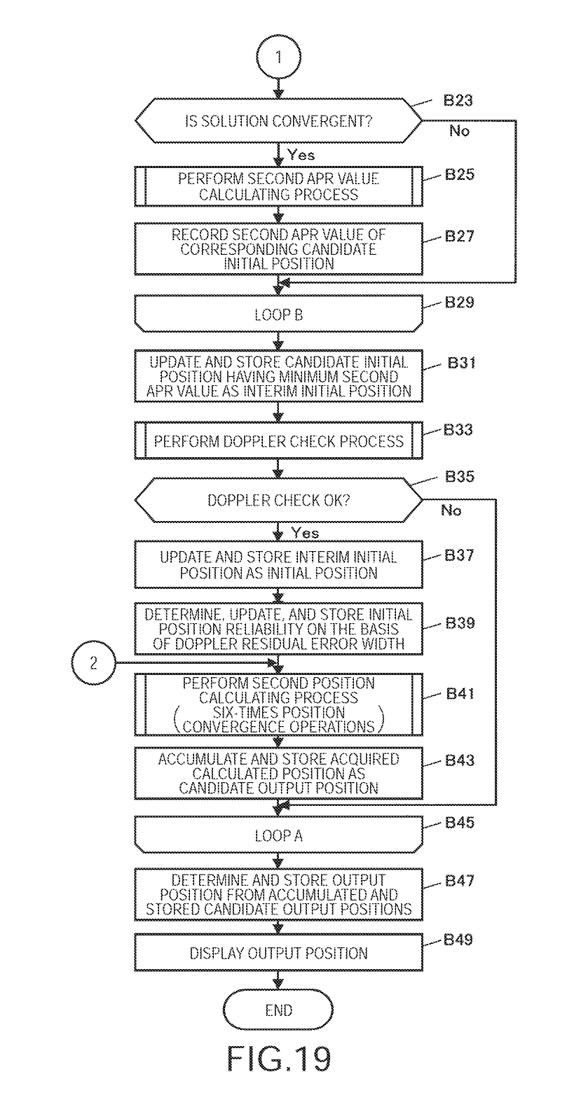

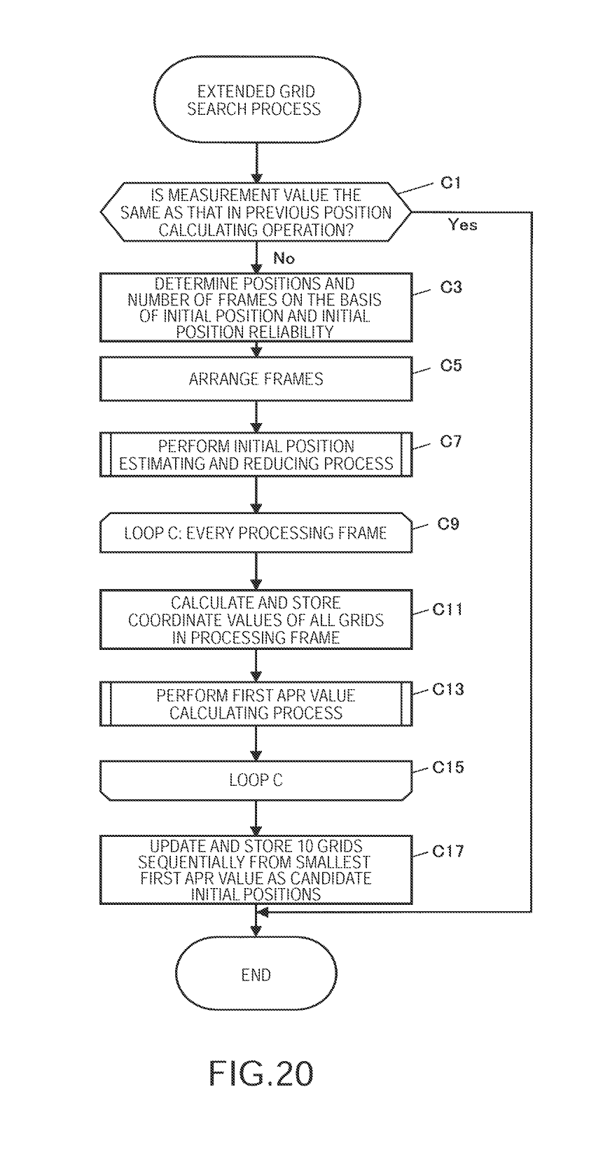

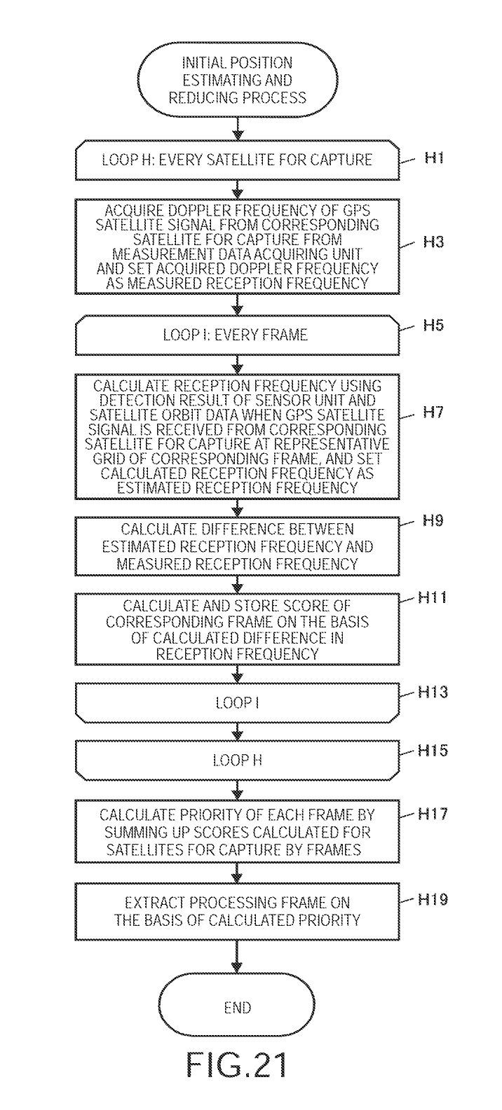

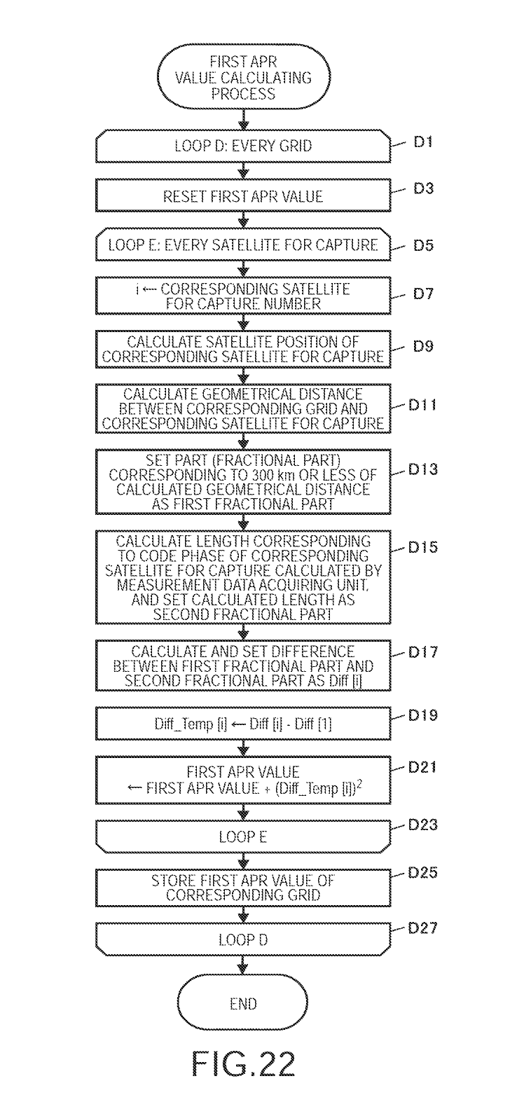

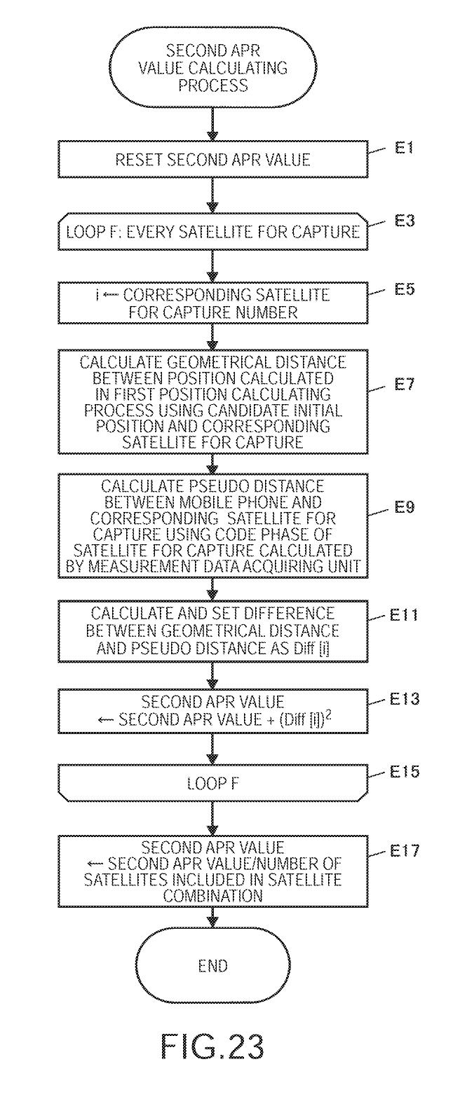

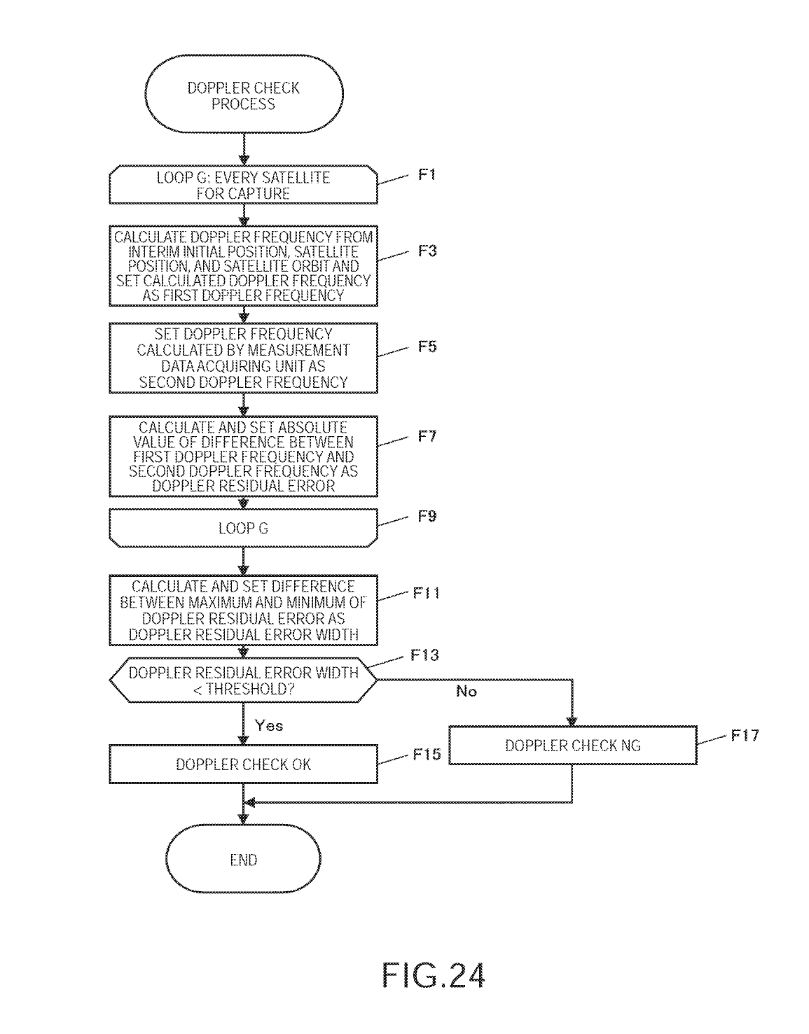

The main program 101 may include as sub routines a position calculating program 1011 executed as a position calculating process (see FIGS. 18 and 19), an extended grid search program 1012 executed as an extended grid search process (see FIG. 20), an initial position estimating and reducing program 1013 executed as an initial position estimating and reducing process (see FIG. 21), a first APR value calculating program 1014 executed as a first APR value calculating process (see FIG. 22), a second APR value calculating program 1015 executed as a second APR value calculating process (see FIG. 23), a Doppler check program 1016 executed as a Doppler check process (see FIG. 24), a first position calculating program 1017 executed as a first position calculating process, and a second position calculating program 1018 executed as a second position calculating process. These processes will be described in detail later with reference to the flowcharts.

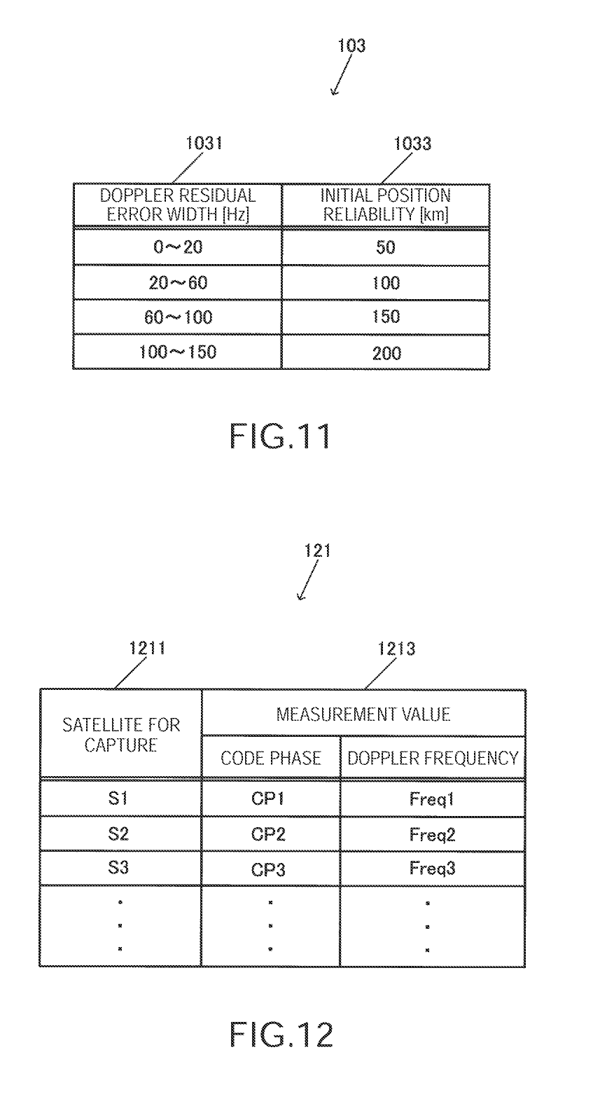

FIG. 11 is a diagram illustrating an example of the data structure of the initial position reliability setting data 103. A Doppler residual error width 1031 and an initial position reliability 1033 are correlated and stored in the initial position reliability setting data 103. For example, when the Doppler residual error width 1031 is in the range of “20 to 60 Hz”, the initial position reliability 1033 is “100 km”.

The Doppler residual error width 1031 is the width of a difference (hereinafter referred to as “Doppler residual error”) between a calculated theoretical Doppler frequency and a Doppler frequency calculated by the measurement data acquiring unit 33 using an interim initial position (hereinafter, referred to as “interim initial position”) for each satellite for capture. More specifically, the Doppler residual error width 1031 may be obtained by subtracting the minimum value of the Doppler residual errors calculated for the satellites for capture from the maximum value.

The initial position reliability 1033 is an indicator value indicating the degree of reliability of the initial position 111 and is expressed as a magnitude of an error which may be included in the initial position 111. For example, when the initial position reliability 1033 is “100 km”, it means that the maximum error of “100 km” can be included in the initial position 111.

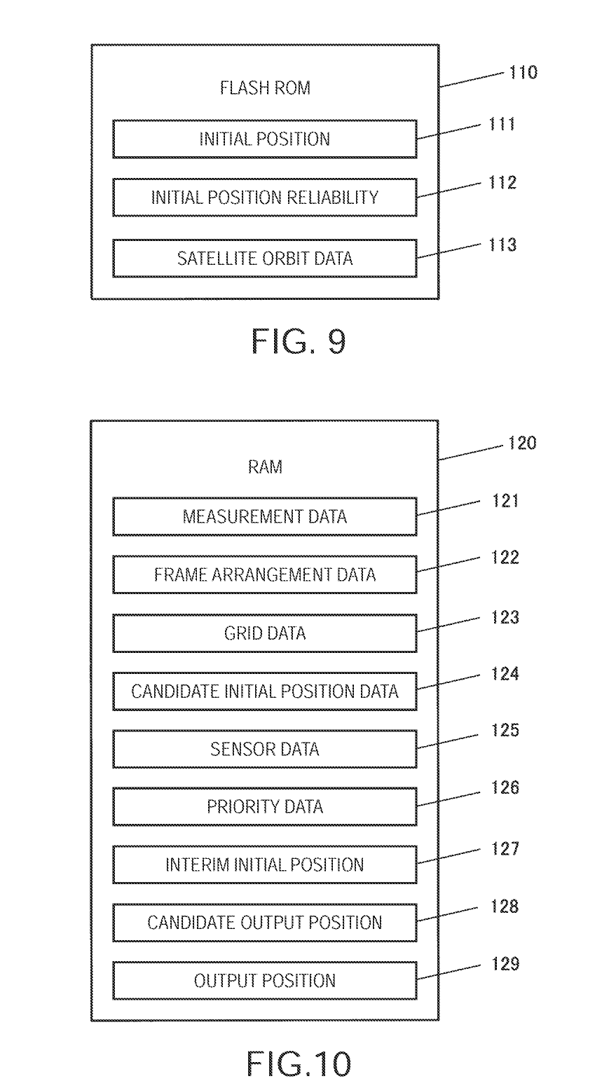

FIG. 9 is a diagram illustrating an example of data stored in the flash ROM 110. An initial position 111, an initial position reliability 112, and satellite orbit data 113 are stored in the flash ROM 110.

The initial position 111 is an initial position of the mobile phone 2 used in the position calculating operation. When the position calculating operation is first carried out after the mobile phone 2 is turned on or when a predetermined time passes after the previous position calculating operation is carried out, the host CPU 50 acquires the rough position of the mobile phone 2 by communicating with the base station 3 and updates and stores the acquired rough position as the initial position 111 in the flash ROM 110.

The initial position reliability 112 is an indicator value indicating the degree of reliability of the initial position 111, and may correspond to the initial position reliability 1033 shown in FIG. 11. The host CPU 50 acquires the reliability of the rough position from the base station 3 and updates and stores the acquired reliability of the rough position as the initial position reliability 112 in the flash ROM 110.

The satellite orbit data 113 may include data on satellite orbits of the GPS satellites SV such as almanac or ephemeris. The satellite orbit data 113 may be acquired from the base station by server assist or by decoding the GPS satellite signals captured by the baseband processing circuit unit 30.

FIG. 10 is a diagram illustrating an example of data stored in the RAM 120. Measurement data 121, frame arrangement data 122, grid data 123, candidate initial position data 124, sensor data 125, priority data 126, an interim initial position 127, a candidate output position 128, and an output position 129 may be stored in the RAM 120.

FIG. 12 is a diagram illustrating an example of the data structure of the measurement data 121. The measurement data 121 stores a measurement value 1213 including a code phase and a Doppler frequency of the satellites for capture 1211. The host CPU 50 acquires the measurement value 1213 from the measurement data acquiring unit 33 and stores the acquired measurement value 1213 in the measurement data 121 so as to be correlated with the satellite for capture 1211.

The frame arrangement data 122 of FIG. 10 is data on the arrangement of frames such as the frames F1 to F9 shown in FIG. 3 and includes, for example, the coordinate values of the frames.

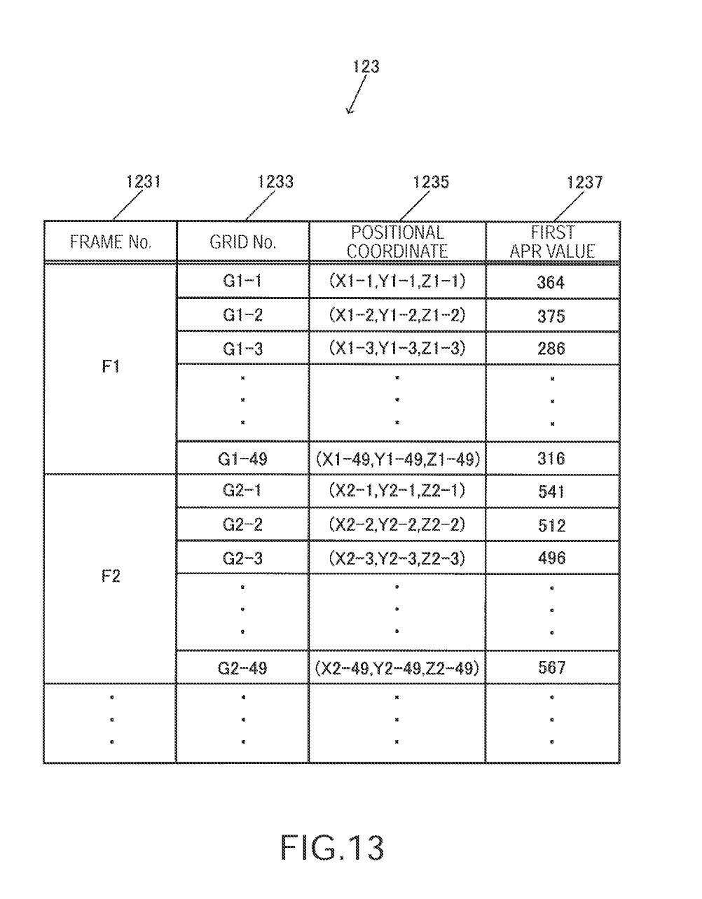

FIG. 13 is a diagram illustrating an example of the data structure of the grid data 123. The grid data 123 is data on all the grids of all the frames and stores a frame number 1231, a grid number 1233 included in the frames, a positional coordinate 1235 of each grid included in the grid, and a first APR value 1237 calculated for each grid so as to be correlated with each other.

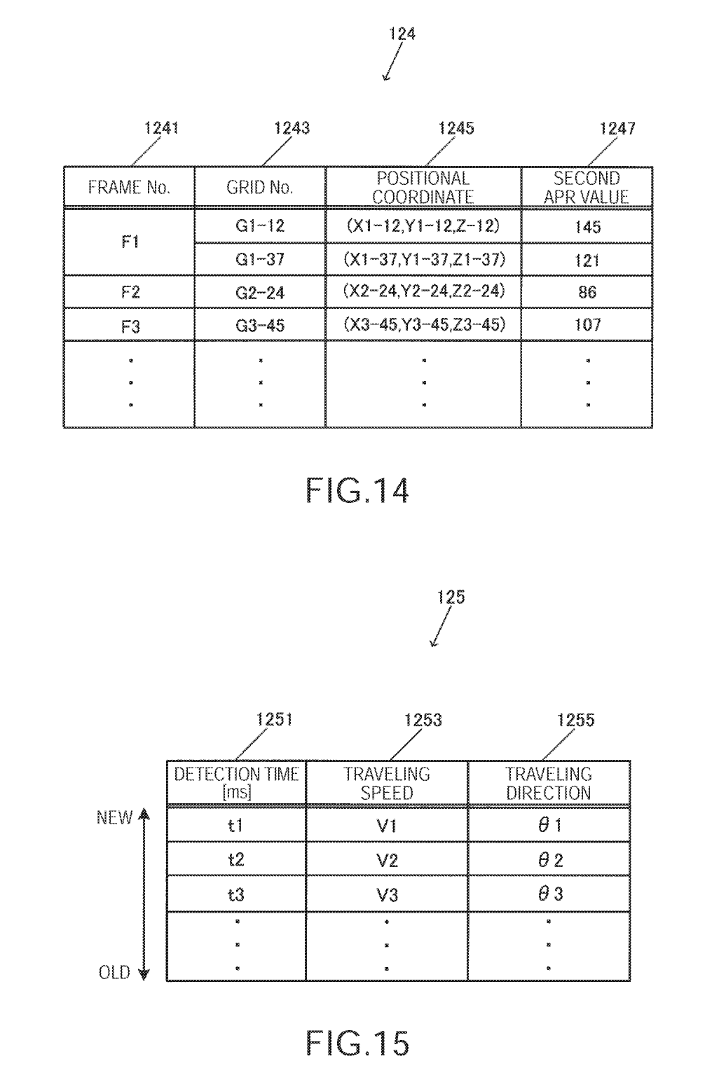

FIG. 14 is a diagram illustrating an example of the data structure of the candidate initial position data 124. The candidate initial position data 124 is data on the grids selected as the candidate initial positions, and stores a frame number 1241, a grid number 1243, a positional coordinate 1245 of each grid, and a second APR value 1247 so as to be correlated with each other.

FIG. 15 is a diagram illustrating an example of the data structure of the sensor data 125. The sensor data 125 stores a traveling speed 1253 detected by the speed sensor 91 and a traveling direction 1255 detected by the direction sensor 93 so as to be correlated with the detection time 1251 (for example, millisecond).

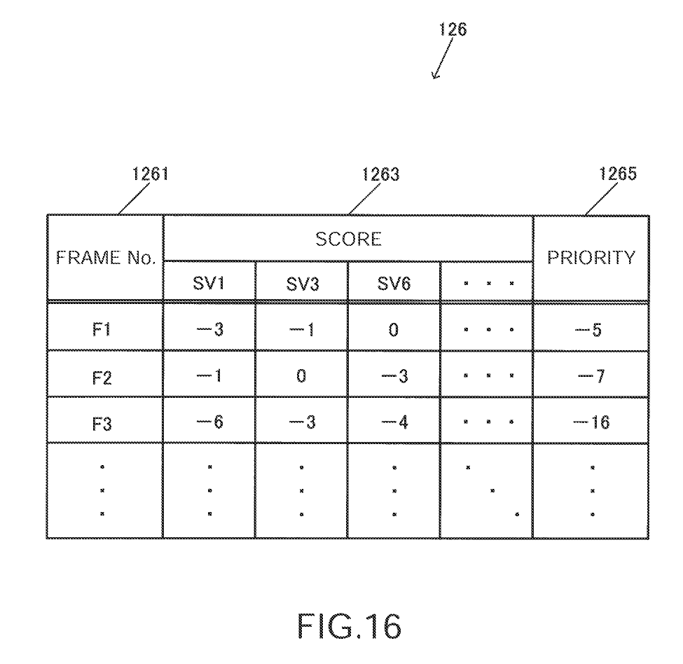

FIG. 16 is a diagram illustrating an example of the data structure of the priority data 126. The priority data 126 stores a frame number 1261, a satellite for capture score 1263 of each frame, and a priority 1265 so as to be correlated with each other.

An interim initial position 127 of FIG. 10 is a position corresponding to the grid determined as the interim initial position out of the candidate initial positions. The candidate output position 128 of FIG. 10 is a position calculated as a candidate of the output position by the second position calculating process. The output position 129 of FIG. 10 is a position finally determined as the position to be output to the display unit 70.

### 5. Flow of Processes

FIG. 17 is a flowchart illustrating an example of a main process performed by the mobile phone 2 causing, for example, the host CPU 50 to read and execute the main program 101 stored in the ROM 100.

The main process is a process which may be executed when the host CPU 50 detects that it is turned on by a user by the use of the operation unit 60. Although not particularly described, it may be assumed that the reception of the RF signal in the GPS antenna 10 or the down-conversion of the RF signal into the IF signal in the RF receiving circuit unit 21 and the capturing and extracting of the GPS satellite signal from the IF signal in the baseband processing circuit unit 30 or the calculation of the measurement value in the measurement data acquiring unit 33 is carried out during the execution of the main process. It is also assumed that the traveling state of the mobile phone 2 is detected by the sensor unit 90.

First, the host CPU 50 determines what an instructing operation from the operation unit 60 is (step A1), and performs the telephone call process (step A3) when it is determined that the instructing operation is a telephone call instructing operation (telephone call instructing operation in step A1). Specifically, the mobile-phone RF communication circuit unit 80 is made to make a communication with the base station 3, thereby embodying the telephone call communication between the mobile phone 2 and another mobile phone.

When it is determined in step A1 that the instructing operation is an e-mail transmission and reception instructing operation (mail transmission and reception instructing operation in step A1), the host CPU 50 performs the e-mail transmitting and receiving process (step A5). Specifically, the mobile-phone RF communication circuit unit 80 is made to make a communication with the base station, thereby embodying the e-mail transmission and reception between the mobile phone 2 and another mobile phone.

When it is determined in step A1 that the instructing operation is a position calculation instructing operation (position calculation instructing operation in step A1), the host CPU 50 performs the position calculating process by reading and executing the position calculating program 1011 stored in the ROM 100 (step A7).

FIGS. 18 and 19 are flowcharts illustrating examples of the position calculating process. As noted above, these flowcharts represent examples of the position calculating process, and many other variations are possible.

First, the host CPU 50 may determine whether a first position calculation is performed after it is turned on or whether a predetermined time passes after the previous position calculation is performed (step B1), and performs the process of step B5 when it is determined that the above-mentioned condition is not satisfied (NO in step B1). When it is determined that the above-mentioned condition is satisfied (YES in step B1), the host CPU acquires the rough position of the mobile phone 2 and the reliability thereof from the communication base station 3 and updates and stores the rough position and the reliability as the initial position 111 and the initial position reliability 113 in the flash ROM 110 (step B3).

Then, the host CPU 50 performs a satellite for capture determining process using the initial position 111 and the satellite orbit data 113 stored in the flash ROM 110 (step B5). The host CPU may determine a GPS satellite SV located at the sphere of the initial position 111 as a satellite for capture on the basis of the satellite orbit data 113.

Thereafter, the host CPU 50 determines whether the number of satellites for capture is 4 or more (step B7), and performs the process of step B5 again when it is determined that the number of satellites for capture is less than 4 (NO in step B7).

When it is determined that the number of satellites for capture is 4 or more (YES in step B7), the host CPU 50 extracts a combination of satellites for capture (hereinafter, referred to as “satellite combination”) (step B9). For example, when the number of satellites for capture is 6, 22 satellite combinations in a total of combinations including four satellites (₆C₄=15), combinations including five satellites (₆C₅=6), and combinations including six satellites (₆C₆=1) are extracted.

Then, the host CPU 50 performs the processes of loop A (steps B11 to B45) on the satellite combinations extracted in step B9. In the processes of loop A, the host CPU 50 determines whether the initial position reliability 112 stored in the flash ROM 110 is greater than 150 km (step B13), and performs the process of step B41 when it is determined the initial position reliability 112 is equal to or less than 150 km (NO in step B13).

When it is determined that the initial position reliability 112 is greater than 150 km (YES in step B13), the host CPU 50 performs the extended grid search process by reading and executing the extended grid search program 1012 stored in the ROM 110 (step B15).

FIG. 20 is a flowchart illustrating an example of the extended grid search process (step B15), although other types of extended grid search processes may be used in other embodiments. First, the host CPU 50 determines whether the measurement value calculated by the measurement data acquiring unit 33 is the same as that acquired in the previous position calculating operation (step C1). When it is determined that the measurement value is not the same as acquired in the previous position calculating operation (NO in step C1), the host CPU 50 determines the positions of the frames on the basis of the initial position 111 stored in the flash ROM 110 and determines the number of frames on the basis of the initial position reliability 112 (step C3). The host CPU 50 imaginarily arranges the frames on the earth's surface on the basis of the determined positions and number (step C5).

More specifically, the frames of the number corresponding to the initial position reliability 112 are arranged using the initial position 111 stored in the flash ROM 110 as the center grid. For example, when the error range is “600 km to 1000 km”, as shown in FIG. 3, the frame F1 centered on the initial position 111 is arranged at the center and eight frames F2 to F9 are arranged around it. When the error range is “300 km to 600 km, four frames of 2×2 frames are arranged. When the error range is “1000 km to 1300 km, sixteen frames of 4×4 frames are arranged. Thereafter, whenever the error range increases by 300 km, the number of frames to be arranged is also made to increase.

Then, the host CPU 50 performs the initial position estimating and reducing process by reading and executing the initial position estimating and reducing program 1013 stored in the ROM 100 (step C7).

FIG. 21 is a flowchart illustrating an example of the initial position estimating and reducing process (step C7), although other types of initial position estimating and reducing processes may be used in other embodiments.

First, the host CPU 50 performs the processes of loop H on each satellite for capture (steps H1 to H15 of FIG. 21). In the processes of loop H, the host CPU 50 acquires the Doppler frequency of the GPS satellite signal received from the corresponding satellite for capture from the measurement data acquiring unit 33 and sets the acquired Doppler frequency as the measured reception frequency (step H3).

Thereafter, the host CPU 50 performs the processes of Loop I on each frame arranged in step C5 (steps H5 to H13). In the processes of Loop I, the host CPU 50 calculates the reception frequency at the time of receiving the GPS satellite signal from the corresponding satellite for capture at the representative grid of the corresponding frame using the detection result of the sensor unit 90 and the satellite orbit data 113 stored in the flash ROM 110 and sets the calculated reception frequency as the estimated reception frequency (step H7).

Then, the host CPU 50 calculates a difference between the estimated reception frequency calculated in step H7 and the measured reception frequency acquired in step H3 (step H9). The host CPU 50 calculates the frame score 1263 on the basis of the calculated difference in reception frequency and stores the calculated score in the priority data 126 of the RAM 120 (step H11). Then, the host CPU 50 changes the flow of processes to the next frame.

After the processes of H7 to H11 are performed on all the frames, the host CPU 50 ends the processes of Loop I (step H13). Then, the host CPU 50 changes the flow of processes to the next satellite for capture. After the processes of steps H3 to H13 are performed on all the satellites for capture, the host CPU 50 ends the processes of Loop H (step H15).

Thereafter, and referring to FIG. 17, the host CPU 50 calculates the priority 1265 of each frame by summing up the scores 1263 calculated for each satellite for capture in step H11 by frames, and stores the calculated priorities in the priority data 126 of the RAM 120 (step H17). The host CPU 50 extracts the processing frames on the basis of the calculated priorities (step H19) and ends the initial position estimating and reducing process.

Referring to the extended grid search process of FIG. 20 again, the host CPU 50, having performed the initial position estimating and reducing process (step C7), performs the processes of Loop C on each processing frame extracted in step H19 (steps C9 to C15). In the processes of Loop C, the host CPU 50 calculates the positional coordinates 1235 of all the grids in the corresponding frame and stores the calculated positional coordinates in the grid data 123 of the RAM 120 so as to be correlated with the frame number 1231 and the grid number 1233 (step C11).

Thereafter, the host CPU 50 performs the first APR value calculating process by reading and executing the first APR value calculating program 1014 stored in the ROM 100 (step C13).

FIG. 22 is a flowchart illustrating an example of the first APR value calculating process (step C13), although other types of APR value calculating processes may be used in other embodiments.

First, the host CPU 50 performs the processes of Loop D on the grids in the corresponding frame (steps D1 to D27). In the processes of Loop D, the host CPU 50 resets the first APR value 1237 of the corresponding grid stored in the grid data 123 of the RAM 120 (step D3).

Thereafter, the host CPU 50 performs the processes of Loop E on all the satellites for capture (step D5 to D23). In the processes of Loop E, the host CPU 50 replaces “i” with the satellite for capture number (step D7). The host CPU 50 calculates the positional coordinates of the corresponding satellite for capture on the basis of the satellite orbit data 113 stored in the flash ROM 110 (step D9).

The host CPU 50 calculates the geometrical distance “GR” between the grid and the satellite for capture on the basis of the positional coordinates 1235 of the grid stored in the grid data 123 and the positional coordinates of the satellite for capture calculated in step D9 (step D11).

The host CPU 50 calculates the part (fractional part) of the calculated geometrical distance GR equal to or less than 300 km and sets the calculated part as the first fractional part (step D13). The host CPU 50 calculates the length corresponding to the code phase of the satellite for capture calculated by the measurement data acquiring unit 33 and sets the calculated length as the second fractional part (step D15).

The host CPU 50 calculates a difference between the first fractional part calculated in step D13 and the second fractional part calculated in step D15 and sets the calculated difference as Diff[i] (step D17). The host CPU 50 subtracts Diff[1] calculated for the first satellite for capture from Diff[i] calculated for the satellite for capture and sets the acquired result as Diff_Temp[i] (step D19).

The host CPU 50 adds the square of Diff_Temp[i] calculated in step D19 to the first APR value to update the first APR value 1237 (step D21). The host CPU 50 changes the flow of processes to the next satellite for capture.

After the processes of steps D7 to D21 are performed on all the satellites for capture, the host CPU 50 ends the processes of Loop E (step D23). After ending the processes of Loop E, the host CPU 50 stores the first APR value 1237 of the grid in the grid data 123 of the RAM 120 (step D25) and then changes the flow of processes to the next grid.

After the processes of steps D3 to D25 are performed on all the grids, the host CPU 50 ends the processes of Loop D (step D27). Then, the host CPU 50 ends the first APR value calculating process.

Referring to the extended grid search process of FIG. 20 again, the host CPU 50, having performed the first APR value calculating process, changes the flow of processes to the next frame. After performing the processes of steps C11 and C13 on all the frames, the host CPU 50 ends the processes of Loop C (step C15).

After ending the processes of Loop C, the host CPU 50 extracts “10” grids as the candidate initial positions sequentially from the grid of which the first APR value 1237 stored in the grid data 123 of the RAM 120 is the smallest, and updates and stores the extracted grids in the candidate initial position data 124 of the RAM 120 (step C17). Then, the host CPU 50 ends the extended grid search process.

On the other hand, when it is determined in step C1 that the measurement value is the same as that acquired in the previous position calculating operation (YES in step C1), the host CPU 50 ends the extended grid search process. This is because the processes of steps C3 to C17 may increase the amount of calculation on the basis of the fact that the candidate initial position is the same as that acquired in the previous position calculating operation when the measurement value is the same as that acquired in the previous position calculating operation.

Referring to the position calculating process of FIG. 18 again, the host CPU 50, having performed the extended grid search process, calculates the geometrical distances between the candidate initial positions and the satellites for capture (step B17). Then, the host CPU 50 performs the processes of Loop B on the candidate initial positions (steps B19 to B29).

In the processes of Loop B, the host CPU 50 performs the first position calculating process by reading and executing the first position calculating program 1017 stored in the ROM 100 (step B31). Specifically, the host CPU 50 performs the position convergence operation based on the least square method using the geometrical distances calculated in step B17 and the pseudo distance calculated from the code phase. At this time, the number of repeated convergence operations is set to “2”.

Thereafter, the host CPU 50 determines whether the solution is convergent (step B23), and changes the flow of processes to the next candidate initial position when it is determined that the solution is not convergent (NO in step B23). When it is determined that the solution is convergent (YES in step B23), the host CPU 50 performs the second APR value calculating process by reading and executing the second APR value calculating program 1015 stored in the ROM 100 (step B25).

FIG. 23 is a flowchart illustrating the flow of the second APR value calculating process, although other types of second APR value calculating processes may be used in other embodiments.

First, the host CPU 50 resets the second APR value 1247 of the corresponding candidate initial position stored in the candidate initial position data 124 of the RAM 120 (step E1). Thereafter, the host CPU 50 performs the processes of Loop F on all the satellites for capture (step E3).

In the processes of Loop F, the host CPU 50 replaces “i” with the satellite for capture number (step E5). Then, the host CPU 50 calculates the geometrical distance between the position calculated in the first position calculating process and the satellite for capture using the candidate initial position (step E7). The host CPU 50 calculates the pseudo distance between the mobile phone 2 and the satellite for capture using the code phase of the satellite for capture calculated by the measurement data acquiring unit 33 (step E9).

Then, the host CPU 50 calculates the difference between the geometrical distance calculated in step E7 and the pseudo distance calculated in step E9 and sets the calculated difference as Diff[i] (step E11). The host CPU 50 adds the square of the calculated Diff[i] to the current second APR value to update the second APR value (step E13). Then, the host CPU 50 changes the flow of processes to the next satellite for capture.

After performing the processes of steps E5 to E13 on all the satellites for capture, the host CPU 50 ends the processes of Loop F (step E15). After ending the processes of Loop F, the host CPU 50 divides the second APR value 1247 of the candidate initial position by the number of satellites included in the satellite combination to update the second APR value 1247 (step E17). Then, the host CPU 50 ends the second APR value calculating process.

Referring to the position calculating process of FIG. 19 again, the host CPU 50, having performed the second APR value calculating process, stores the second APR value 1247 of the candidate initial position in the candidate initial position data 124 of the RAM 120 (step B27). Then, the host CPU 50 changes the flow of processes to the next candidate initial position.

After performing the processes of steps B21 to B27 on all the candidate initial positions, the host CPU 50 ends the processes of Loop B (step B29). After ending the processes of Loop B, the host CPU 50 selects the candidate initial position having the minimum second APR value 1247 stored in the candidate initial position data 124 of the RAM 120 as the interim initial position 127, and updates and stores the interim initial position 127 in the RAM 120 (step B31).

Thereafter, the host CPU 50 performs the Doppler check process by reading and executing the Doppler check program 1016 stored in the ROM 100 to determine whether interim initial position 127 is suitable (step B33).

FIG. 24 is a flowchart illustrating the flow of the Doppler check process, although other types of Doppler check processes may be used in other embodiments.

First, the host CPU 50 performs the processes of Loop G on all the satellites for capture (steps F1 to F9). In the processes of Loop G, the host CPU 50 calculates the Doppler frequency on the basis of the interim initial position 127 stored in the RAM 120, the satellite position of the corresponding satellite for capture, and the satellite orbit data 113 stored in the flash ROM 110, and sets the calculated Doppler frequency as the first Doppler frequency (step F3).

The host CPU 50 sets the Doppler frequency acquired by the measurement data acquiring unit 33 as the second Doppler frequency (step F5). Then, the host CPU 50 calculates the absolute value of the difference between the first Doppler frequency and the second Doppler frequency and sets the calculated absolute value as the Doppler residual error (step F7). The host CPU 50 changes the flow of processes to the next satellite for capture.

After performing the processes of steps F3 to F7 on all the satellites for capture, the host CPU 50 ends the processes of Loop G (step F9). The host CPU 50, having ended the processes of Loop G, calculates the difference between the maximum value and the minimum value of the Doppler residual error and sets the calculated difference as the Doppler residual error width (step F11).

Then, the host CPU 50 determines whether the Doppler residual error width calculated in step F11 is less than a predetermined threshold value (step F13), and determines that the Doppler check is OK (step F15) when it is determined that the Doppler residual error width is less than the threshold value (YES in step F13). When it is determined that the Doppler residual error width is not less than the threshold value (NO in step F13), the host CPU 50 determines that the Doppler check is NG (step F17). Then, the host CPU 50 ends the Doppler check process.

Referring to the position calculating process of FIG. 19 again, the host CPU 50, having performed the Doppler check process, determines whether the Doppler check is OK (step B35), and changes the flow of processes to the next satellite combination when it is determined that the Doppler check is NG (NO in step B35).

When it is determined that the Doppler check is OK (YES in step B35), the host CPU 50 stores the interim initial position 127 stored in the RAM 120 as the initial position 111 in the flash ROM 110 to update the initial position (step B37).

The host CPU 50 reads the initial position reliability 1033 corresponding to the Doppler residual error width 1031 calculated in step F11 with reference to the initial position reliability setting data 103 stored in the ROM 100, and updates and stores the read initial position reliability as the initial position reliability 112 in the flash ROM 110 (step B39).

The host CPU 50 performs the second position calculating process by reading and executing the second position calculating program 1018 stored in the ROM 100 (step B41). Specifically, the host CPU 50 performs the position convergence operation based on the least square method using the geometrical distances between the initial position 111 stored in the flash ROM 110 and the satellites for capture and the pseudo distance calculated from the code phase. At this time, the number of repeated convergence operations is set to “6”.

The host CPU 50 accumulates and stores the position calculated in the second position calculation process as the candidate output position 128 in the RAM 120 (step B43) and changes the flow of processes to the next satellite combination. After performing the processes of steps B13 to B43 on all the satellite combinations, the host CPU 50 ends the processes of Loop A (step B45).

After ending the processes of Loop A, the host CPU 50 determines the output position 129 from the candidate output positions 128 accumulated and stored in the RAM 120, and stores the determined output position in the RAM 120 (step B47). Specifically, for example, the candidate output position 128 at which the average signal intensity of the satellites for capture is the greatest or the candidate output position 128 at which the PDOP (Position Dilution of Precision) value which is an indicator value indicating the arrangement of the satellites for capture on the sphere is the smallest can be determined as the output position 129.

Then, the host CPU 50 displays a navigation picture in which the output position 129 determined in step B47 is plotted on the display unit 70 (step B49) and then ends the position calculating process.

Referring to the main process of FIG. 17 again, the host CPU 50, having one of the processes of steps A3 to A7, determines whether a power-off instructing operation is carried out by a user by the use of the operation unit 60 (step A9), and performs the process of step A1 again when it is determined that the power-off instructing operation is not carried out (NO in step A9). When it is determined that the power-off instructing operation is carried out (YES in step A9), the host CPU 50 ends the main process.

### 6. Operational Factors

According to one embodiment, frames having a positional range assumed to include the location of the mobile phone 2 and having 300 square km are set on the earth. The estimated reception frequency of the GPS satellite signals, when it is assumed that the mobile phone travels at the traveling speed in the traveling direction detected by the sensor unit at the representative grid of each frame, is calculated for each of the plural set frames. The processing frame, including the position to be set as the initial position, is extracted from the plural frames on the basis of the difference between the measured reception frequency at the time of receiving the GPS satellite signals and the estimated reception frequency. The position to be set as the initial position is determined in the extracted processing frame using the GPS satellite signals.

By setting frames and making a calculation, it may be possible to determine the initial position even when a position greatly apart from the true position of the mobile phone 2 is given. When the representative grid of the frame is close to the true position of the mobile phone 2, the estimated reception frequency, when it is assumed that the GPS satellite signals are received at the representative grid, will be close to the measured reception frequency at the time of actually receiving the GPS satellite signals and, thus, the difference between the measured reception frequency and the estimated reception frequency will be reduced. Accordingly, by reducing the frames on the basis of the difference between the measured reception frequency and the estimated reception frequency, it may be possible to reduce the amount of calculation and to acquire the initial position close to the true position. At this time, by calculating the estimated reception frequency in consideration of the traveling speed and the traveling direction of the mobile phone 2, it is possible to calculate the accurate reception frequency in consideration of the Doppler based on the traveling of the mobile phone 2, thereby improving the accuracy of the acquired initial position.

In some embodiments, a rough position which may have an error greater than 150 km and the reliability indicating the error of the rough position are acquired from the base station 3 as an external system. The positions and the number of frames to be set are determined on the basis of the acquired rough position and reliability. Accordingly, even when a rough position apart by 500 km or 1000 km from the true position of the mobile phone 2 is given, it is possible to determine the initial position by setting the proper positions and number of frames.

The estimated reception frequency of each of the GPS satellite signals from the GPS satellites may be calculated, and the difference between the measured reception frequency and the estimated reception frequency may be calculated for each GPS satellite. The scores may be calculated on the basis of the calculated differences in reception frequency, the scores calculated for the GPS satellites may be summed up, the priority of each frame calculated, and then the processing frame is extracted on the basis of the calculated priority values.

The true position of the mobile phone 2 is probably included in the frame having the small difference between the measured reception frequency and the estimated reception frequency. It can be thought that the true position is included in the frame of which the differences in reception frequency are similarly reduced as the calculation result for the plural GPS satellites. Accordingly, it is possible to acquire the initial position as close to the true position as possible, by summing up the differences in reception frequency calculated for the plural GPS satellites every frame and reducing the frames.

### 7. Modified Example

### 7-1. Electronic Apparatus

Although it has been described in the above-mentioned embodiment that the mobile phone is employed as an electronic apparatus having the position calculating device, electronic apparatuses such as a notebook computer or a PDA (Personal Digital Assistant) may be employed.

### 7-2. Satellite Position Calculating System

Although it has been described in the above-mentioned embodiment that the GPS is employed as a satellite position calculating system, other satellite position calculating systems such as a WAAS (Wide Area Augmentation System), a QZSS (Quasi Zenith Satellite System), a GLONASS (GLObal NAvigation Satellite System), and a GALILEO may be employed.

### 7-3. Specialization of Processes

A part or all of the processes executed by the host CPU 50 may be carried out by the operation controller 31 of the baseband processing circuit unit 30. For example, although it bas been described in the above-mentioned embodiment that the host CPU 50 carries out the reduction of the grids or the position calculating operation (position convergence operation), these processes may be executed by the operation controller 31.

### 7-4. Fitness Determination of Interim Initial Position

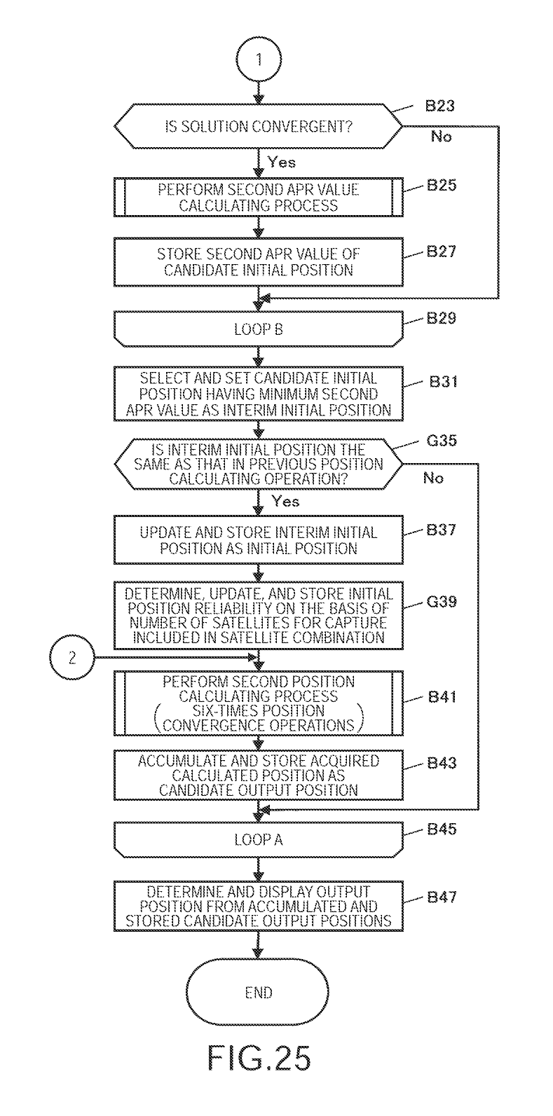

Although it has been described in the above-mentioned embodiment that the fitness of the interim initial position is determined by performing the Doppler check process, the fitness of the interim initial position may be simply determined without performing the Doppler check process. The processes in this case will be described with reference to FIG. 25.

Specifically, a second position calculating process in which steps B33, B35, and B39 in the position calculating process shown in FIGS. 18 and 19 are replaced with steps G35 and G39, is shown in FIG. 25. FIG. 25 shows a flowchart illustrating a part of the second position calculating process corresponding to the position calculating process shown in FIG. 19.

In the second position calculating process, after the interim initial position is determined in step B31, the host CPU 50 determines whether the determined interim initial position is the same as the interim initial position in the previous position calculation operation (step G35). When it is determined that the determined interim initial position is not the same as that in the previous interim initial position (NO in step G35), the host CPU 50 changes the flow of processes to the next satellite combination.

When it is determined that the determined interim initial position is the same as that in the previous interim initial position (YES in step G35), the host CPU 50 updates and stores the interim initial position determined in step B31 as the initial position in the flash ROM 110 (step B37). That is, when the same interim initial position is successively acquired, it is determined that the interim initial position is proper.

The host CPU 50 determines the initial position reliability on the basis of the number of satellites for capture included in the corresponding satellite combination, and updates and stores the determined initial position reliability in the flash ROM 110 (step G39). Specifically, the initial position reliability is set to 50 km, for example, when the number of satellites for capture included in the satellite combination is 6 or more, and the initial position reliability is set to 100 km when the number of satellites for capture is 5. In addition, the initial position reliability is set to 150 km when the number of satellites for capture is 4. That is, the initial position reliability is set to be higher as the number of satellites for capture becomes greater.

### 7-5. Weighting Based on Signal Intensity

Although it has been described in the above-mentioned embodiment that the priority of each frame is calculated by simply summing up the scores of the frame calculated for the satellites for capture, other methods of calculating the priority may be employed. For example, the priority may be calculated by weighting the satellites for capture on the basis of the signal intensities of the received GPS satellite signals and weight-averaging the scores of the frame.

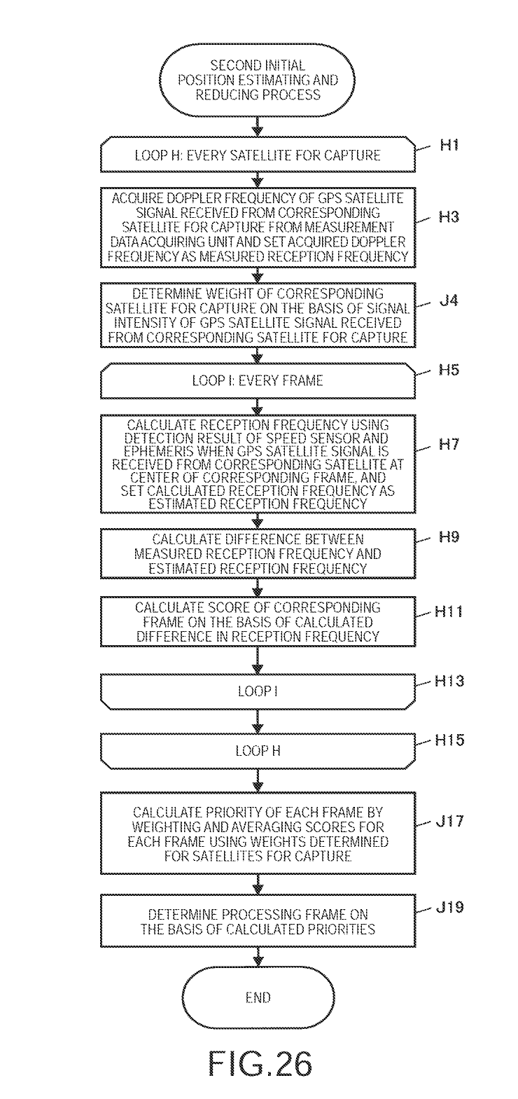

FIG. 26 is a flowchart illustrating the flow of a second initial position estimating and reducing process which is a process performed instead of the initial position estimating and reducing process by the host CPU 50. The same steps as the initial position estimating and reducing processes shown in FIG. 21 will be referenced by the same reference signs and the description thereof will not be repeated, but only the parts different from the initial position estimating and reducing process will be described.

In the second initial position estimating and reducing process, the host CPU 50 determines the weight “ω” of a satellite for capture on the basis of the signal intensity of the GPS satellite signal received from the satellite for capture during the processes of loop H performed on the satellites for capture (step J4).

As a satellite transmits a GPS satellite signal with higher signal intensity, the calculated score in the frame has higher reliability. Accordingly, the weight “ω” is determined so that the weight value becomes greater as the satellite for capture transmits the GPS satellite signal with the higher signal intensity. In this case, it is preferable that the weight “ω” is normalized so that Expression 3 is satisfied.

$${\sum }_{i}^{N} {ω}_{i} = 1 \qquad ( 3 )$$

Here, the subscript “i” represents the satellite for capture number and “N” represents the number of satellites for capture.

The host CPU 50 calculates the priority of each frame by calculating the weighted average of the scores calculated in step H11 by frames using the weight “ω” determined in step J4 for the satellites for capture after performing the processes of Loop H (step J17). Specifically, the priority “Pⱼ” is calculated by the use of Expression 4.

$${P}_{j} {\sum }_{i}^{N} {ω}_{i} {p}_{ij} \qquad ( 4 )$$

Here, “p” represents the score of the frame and the subscript “j” represents the frame number.

The host CPU 50 extracts the processing frame on the basis of the priority calculated in step J17 (step J19) and then ends the second initial position estimating and reducing process.

The priority may be similarly calculated on the basis of an elevation angle of the GPS satellite instead of the signal intensity of the GPS satellite signal. That is, the score of the frame calculated for the satellite having a greater elevation angle is more highly reliable. Accordingly, the satellite for capture having a higher elevation angle is set to a greater weight and the scores of the frame are weight-averaged.

### 7-6. Output Position

Although it has been described in the above-mentioned embodiment that the output position is determined by first determining the initial position and performing the second position calculating process using the determined initial position, the initial position may be determined as the output position without performing the second position calculating process. This is because the initial position close to the true position of the position calculating device can be acquired by reducing the grids using the above-mentioned principle.

### 7-7. Reduction of Grids

Although it has been described in the above-mentioned embodiment that the first APR value is calculated for all the grids using the difference between the fractional part of the geometrical distance and the fractional part of the pseudo distance, the first APR value may be calculated using the difference between the entire geometrical distance and the entire pseudo distance instead of using the fractional parts and the grids may be reduced.

Instead of calculating the APR value using the difference in distance, the APR value may be calculated using the difference in Doppler frequency to reduce the grids. That is, the APR value may be calculated by calculating the difference between the theoretically calculated Doppler frequency and the actually measured Doppler frequency for each satellite for capture and calculating the sum of squares thereof. The grids are reduced by extracting the grids sequentially from the grid having the smallest APR value.

### 7-8. Frames and Grids

Although it has been described in the above-mentioned embodiment that the grids are arranged in a lattice shape with a pitch of 50 km in a frame of 300 square km, the arrangement pitch of the grids may be properly changed. With the decrease in arrangement pitch of the grids, it is possible to acquire the initial position closer to the true position, but the amount of calculation increases by as much.

The shape of frame is not necessarily rectangular, but may be circular. Similarly, the arrangement shape of the grids is not necessarily lattice-shaped, but may be concentric or spiral.

### 7-9. Satellite Combination

Although it has been described in the above-mentioned embodiment that the processes of steps B11 to B45 are performed on all the satellite combinations extracted in step B9 of the position calculating process shown in FIGS. 18 and 19, the processes of steps B11 to B45 may be performed only on the satellite combination of which the PDOP value is equal to or less than a predetermined threshold value or the satellite combination of which the average of the signal intensities of the captured GPS satellite signals is equal to or greater than a predetermined threshold value out of the satellite combinations extracted in step B9. Accordingly, it may be possible to reduce the amount of calculation.

What is claimed is:

1. An initial position determining method, the method comprising:
setting a plurality of candidate ranges;
receiving a satellite signal from a positioning satellite;
calculating an estimated reception frequency of the satellite signal at a representative position of each of at least a subset of the plurality of candidate ranges;
selecting a range from the plurality of candidate ranges based at least in part on a difference between a reception frequency measured substantially at the time of receiving the satellite signal and the estimated reception frequency; and
identifying the representative position from the selected range as the initial position to be used for a position calculating operation performed using one or more signals from the positioning satellite.

2. The method of claim 1, further comprising:
detecting a traveling speed and a traveling direction, wherein the estimated reception frequency is calculated using the traveling speed and the traveling direction.

3. The method claim 1, further comprising:
receiving identification of a rough position and a reliability indication for the rough position; and
determining a number of candidate ranges to be set based at least in part on the rough position and the reliability indication.

4. The method claim 1, further comprising:
receiving identification of a rough position and a reliability indication for the rough position; and
identifying a location for the plurality of candidate ranges based at least in part on the rough position and the reliability indication.

5. The method of claim 1, further comprising:
calculating, for each of the plurality of candidate ranges, an estimated reception frequency for each of a plurality of additional positioning satellites;
calculating, for each of the plurality of candidate ranges, differences between the estimated reception frequencies of the additional positioning satellites and the measured reception frequency; and
summing up the calculated differences for each of the plurality of candidate ranges, wherein the range is selected based at least in part on the summed differences.

6. The method of claim 5, further comprising:
measuring a signal strength for signals from each of the additional positioning satellites; and
weighting the calculated differences responsive to the measured signal strength, wherein summing up the calculated differences comprises summing up the weighted calculated differences.

7. The method of claim 1, further comprising:
establishing a grid pattern corresponding to an area of the earth, wherein each of the plurality of candidate ranges corresponds to a grid of the grid pattern.

8. The method of claim 1, further comprising:
setting a plurality of candidate positions in the plurality of candidate ranges;
selecting a subset of the plurality of candidate positions based at least in part on a difference between a geometrical distance between the plurality of candidate positions and the positioning satellites and a pseudo distance calculated using the satellite signals from the positioning satellites;
reducing the plurality of candidate positions to the selected subset; and
calculating the difference between the measured reception frequency and the estimated reception frequency for the selected reduced plurality of candidate positions.

9. The method of claim 1, further comprising:
calculating a position at which the position calculating operation is carried out using the initial position.

10. The method of claim 1, wherein:
the method is performed by a mobile phone; and
the positional satellite comprises a global positioning system satellite.

11. A position calculating device comprising:
a receiver module configured to receive a satellite signal from a positioning satellite;
a processor module, communicatively coupled with the receiver module, and configured to: p2 set a plurality of candidate ranges;
calculate an estimated reception frequency of the satellite signal at a representative position of each of at least a subset of the plurality of candidate ranges;
select a range from the plurality of candidate ranges based at least in part on a difference between a reception frequency measured substantially at the time of receiving the satellite signal and the estimated reception frequency; and
identify the representative position from the selected range as the initial position to be used for a position calculating operation performed using one or more signals from the positioning satellite.

12. The device of claim 11, further comprising a sensor module, communicatively coupled with the processor module, and configured to detect a traveling speed and a traveling direction, wherein the estimated reception frequency is calculated using the traveling speed and the traveling direction.

13. The device of claim 11, further comprising a mobile phone receiver, communicatively coupled with the processor module, and configured to:
receive identification of a rough position and a reliability indication for the rough position from a base station,
wherein the processor module is further configured to determine a number of candidate ranges to be set based at least in part on the rough position and the reliability indication.

14. The device of claim 11, further comprising a mobile phone receiver, communicatively coupled with the processor module, and configured to:
receive identification of a rough position and a reliability indication for the rough position from a base station,
wherein the processor module is further configured to identify a location for each of the plurality of candidate ranges based at least in part on the rough position and the reliability indication.

15. The device of claim 11, wherein the processor module is further configured to:
calculate, for each of the plurality of candidate ranges, an estimated reception frequency for each of a plurality of additional positioning satellites;
calculate, for each of the plurality of candidate ranges, differences between the estimated reception frequencies of the additional positioning satellites and the measured reception frequency; and
sum the calculated differences for each of the plurality of candidate ranges, wherein the range is selected based at least in part on the summed differences.

16. The device of claim 15, wherein the receiver module is further configured to:
measure a signal strength for signals from each of the additional positioning satellites,
wherein the processor module is further configured to weight the calculated differences according to the measured signal strength.

17. The device of claim 11, wherein the processor module is further configured to establishing a grid pattern corresponding to an area of the earth, wherein each of the plurality of candidate ranges corresponds to a grid of the grid pattern.

18. The device of claim 11, wherein the processor module is further configured to:
set a plurality of candidate positions in the plurality of candidate ranges;
select a subset of the plurality of candidate positions based at least in part on a difference between a geometrical distance between the plurality of candidate positions and the positioning satellites and a pseudo distance calculated using the satellite signals from the positioning satellites;
reduce the plurality of candidate positions to the selected subset; and
calculate the difference between the measured reception frequency and the estimated reception frequency for the reduced plurality of candidate positions.

19. The device of claim 11, wherein the processor module is further configured to calculating a position at which the position calculating operation is carried out using the initial position.

20. The device of claim 11, wherein:
the device comprises a mobile phone;
the positional satellite comprises a global positioning system satellite; and
the processor module comprises a baseband processor module and a central processing unit.
